(19) United States
(12) Patent Application Publication
(10) Pub. No.: US 2026/0160094 A1
(43) Pub. Date: Jun. 11, 2026

(54) ELECTRONIC LOCKSET WITH AUTOMATIC HANDING

(71) Applicant: ASSA ABLOY Americas Residential Inc., New Haven, CT (US)

(72) Inventors: Kevin Coleman, Lake Forest, CA (US); Matthew Denton Lovett, Rancho Santa Margarita, CA (US)

(73) Assignee: ASSA ABLOY Americas Residential Inc., New Haven, CT (US)

(21) Appl. No.: 19/181,127

(22) Filed: Apr. 16, 2025

Related U.S. Application Data
(60) Provisional application No. 63/634,794, filed on Apr. 16, 2024.

(51) Int. Cl. E05B 47/00

(52) U.S. Cl. CPC E05B 47/0012; E05B 2047/0069; E05B 2047/0091; E05B 2047/0094

(57) ABSTRACT

In general, an electronic lockset with automatic handing determination is disclosed. The lockset may be mounted to a door, and the lockset may automatically determine a handing of the door to properly lock and unlock the door. Various techniques are disclosed for determining handing, including analyzing an image of the door, selecting an image of the door, deriving handing based on data captured when swinging a door, determining a location of an external reference point, determining a rotational location of aspects of a latch assembly, performing another technique, or a combination of the described techniques.

### CROSS-REFERENCE TO RELATED APPLICATIONS

The present application claims priority from U.S. Provisional Patent Application No. 63/634,794, filed on April 16, 2024, the disclosure of which is hereby incorporated by reference in its entirety.

### BACKGROUND

Electronic locksets often operate by using a motor to rotate a torque blade or other mechanism, thereby extending or retracting a bolt. The extension or retraction of the bolt is based on a rotational direction driven by the motor.

Determining door handing may be a necessary requirement for an electronic lockset to function properly. If door handing is not properly determined, the lockset may not properly lock or unlock the door. For example, if the rotational direction driven by the motor is selected incorrectly, the lockset may mistakenly extend a bolt when the lockset is supposed to be in an unlocked position, thereby locking the door. As another example, the lockset may mistakenly retract a bolt when the lockset is supposed to be in a locked position, thereby unlocking the door.

Some locksets may be pre-configured to only work with right-handed or left-handed doors. For example, a lockset pre-configured to only work with right-handed doors might be ineffective for left-handed doors, and vice-versa. For locksets configured to work with both right-handed and left-handed doors, a determination of the door handing may be required. However, because door handing can change from one configuration to the next, determining door handing can be a challenge.

### SUMMARY

In general, an electronic lockset with automatic handing determination is disclosed. The lockset may be mounted to a door, and the lockset may determine a handing of the door so that a motor and latch assembly of the lockset operate properly to lock and unlock the door. In some embodiments, an automatic handing determination is made with minimal user input. Various techniques are disclosed for determining handing, including analyzing an image of the door, selecting an image of the door, deriving handing based on data captured when swinging the door, determining a location of an external reference point, determining a rotational location of aspects of a latch assembly, performing another technique, or a combination of the techniques described herein.

In a first aspect, a system for automatically determining a door handing is disclosed. The system comprises an electronic lockset mounted to a door; and a mobile device comprising a camera, a processor, and memory storing instructions; wherein the instructions, when executed by the processor, cause the mobile device to: capture, using the camera, an image of the electronic lockset and the door; analyze the image to determine the door handing; and provide the door handing to the electronic lockset; wherein analyzing the image to determine the door handing comprises: determining a first location of the door in the image; determining a second location of the electronic lockset in the image; and comparing the first location and the second location.

In a second aspect, an electronic lockset mounted to a door is disclosed. The electronic lockset comprises a sensor; a processor; and memory storing instructions; wherein the instructions, when executed by the processor, cause the electronic lockset to: measure, using the sensor, a movement of the electronic lockset or a force on the electronic lockset caused by swinging the door in an arc; determine, based on the movement of the electronic lockset or the force on the electronic lockset, a handing of the door.

In a third aspect, an electronic lockset mounted to a door is disclosed. The electronic lockset comprises a latch assembly comprising a drive shaft; a reference element rotationally coupled with the drive shaft; a sensor; a processor; and memory storing instructions; wherein the instructions, when executed by the processor, cause the electronic lockset to: detect, using the senor, a rotational position of the reference element; and based on the rotational position of the reference element, determine a handing of the door.

In a fourth aspect, a system for automatically determining handing is disclosed. The system comprises a door; an external reference; and an electronic lockset mounted to the door, the electronic lockset comprising: a sensor; a processor; and memory storing instructions; wherein the instructions, when executed by the processor, cause the electronic lockset to: record a first measurement without the external reference; record a second measurement with the external reference; compare the first measurement and the second measurement; based on the comparison of the first measurement and the second measurement, determine a location of the external reference relative to the electronic lockset; and based on the location of the external reference relative to the electronic lockset, determine a handing of the door.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment including an electronic lockset in which aspects of the present disclosure may be implemented.

FIG. 2 illustrates example configurations of a right-handed door and a left-handed door.

FIG. 3 illustrates a side view of a portion of an electronic lockset usable within the environment of FIG. 1.

FIG. 4 illustrates a rear perspective view of a portion of an electronic lock usable within the environments of FIG. 1.

FIG. 5 illustrates a front perspective view of a portion of an electronic lock usable within the environments of FIG. 1.

FIG. 6 illustrates a schematic representation of an electronic lock, in accordance with aspects of the present disclosure.

FIG. 7 illustrates a schematic representation of a mobile device seen in the environment of FIG. 1.

FIG. 8 is a flowchart of an example method for determining door handing using an image.

FIG. 9 illustrates an example user interface of an application for determining door handing.

FIG. 10 is a flowchart of an example method for determining door handing using a door swing.

FIG. 11 illustrates schematic examples of determining door handing using a door swing.

FIG. 12 illustrates aspects of a latch assembly that includes a rotating component.

FIG. 13A illustrates a first schematic representation of sensing regions for determining a rotational position of a reference element.

FIG. 13B illustrates a second schematic representation of sensing regions for determining a rotational position of a reference element.

FIG. 13C illustrates a third schematic representation of sensing regions for determining a rotational position of a reference element.

FIG. 14 is a flowchart of an example method for determining door handing using a reference element.

FIG. 15 illustrates a front perspective view of a door and surrounding components.

FIG. 16 is a flowchart of an example method for determining door handing using a location of an external reference.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As briefly described above, embodiments of the present invention relate to determining door handing. An electronic lockset (also referred to as an electronic lock) may be mounted to a door, and the lockset (or another component) may determine the door’s handing. Once the door’s handing is determined, the lockset may update an internal memory or parameter to reflect the handing of the door to which the lockset is mounted. Based on the door’s handing, the lockset may actuate a motor in a manner that properly locks or unlocks the door. For example, upon receiving an instruction to lock the door, the electronic lockset may initiate the motor to rotate a shaft in an appropriate rotational direction such that a bolt extends from the electronic lockset into a door jamb.

In an example aspect, a camera may capture an image of the lockset and door. An image processing application may analyze the image to determine a handing of the door. The image processing application may use one or more of a plurality of possible techniques for determining the hand of the door based on the captured image. As an example, the image processing application may execute a computer vision algorithm to recognize the door and the lockset. The image processing application may then determine which edge of the door is closest to the lockset. Based on such a determination, the handing of the door may be derived. Other image processing techniques are likewise possible to determine handing and they are further described below. In some embodiments, the image is captured by a camera of a mobile device that includes an application installed thereon for installing or managing a lockset.

In an example aspect, one or more sensors may be used to determine the door’s handing based on data captured by the one or more sensors when the door is swung. For example, a sensor may measure a centripetal force applied on the lockset by swinging the door. In such an example, the handing of the door may be directly related to the detected centripetal force. As another example, the sensor may detect an angular velocity and/or a torque. From such measurements, the lockset (or another computing device) may determine the door’s handing.

In an example aspect, a reference element may be rotationally coupled with a locking mechanism. The lockset may further include a plurality of sensors for detecting the reference element. Depending on the installation of the lockset, there may be a rotational position of the reference element that may only be accessed if the door is right-handed. Similarly, there may be a rotational position of the reference element that may only be accessed if the door is left-handed. By detecting the reference element in one of these mutually exclusive regions, the handing of the door may be determined.

In an example aspect, an external reference element may be used. Based on the position of the external reference element relative to the lockset, the door handing may be determined. For example, the lockset may include a magnetometer, and a magnet may be placed external to the lockset, such as at a strike plate, a hinge, or other external location. By using a magnetometer to detect a location of the external magnet, the handing of the door may be determined. Other techniques for sensing an external object may also be used, such as lidar, radar, or sonar.

Aspects of the present disclosure provide various technical advantages. For example, in some embodiments, the handing of a door may be determined with minimal user input, thereby resulting in a more accurate and faster installation process of an electronic lockset. Indeed, according to some embodiments of the present disclosure, the lockset may determine handing without the user being aware that determining handing is part of installing a lock; as a result, the user experience of installing a lock is improved, and reliance on user action to correctly set handing is reduced.

Yet still, aspects of the present disclosure provide a way to verify that the handing of a door on which the lock is installed is correctly determined. Furthermore, by increasing an accuracy of a handing determination, the chances that a lockset is configured with an incorrect door handing is decreased, thereby increasing lock performance and improving the security provided by a lock. Furthermore, in some embodiments of the present disclosure, handing may be automatically determined based on regular use of a lock or door, thereby removing, from a user’s point of view, an additional step of determining handing during installation. As will be apparent these are only some of the benefits and advantages of aspects of the present disclosure.

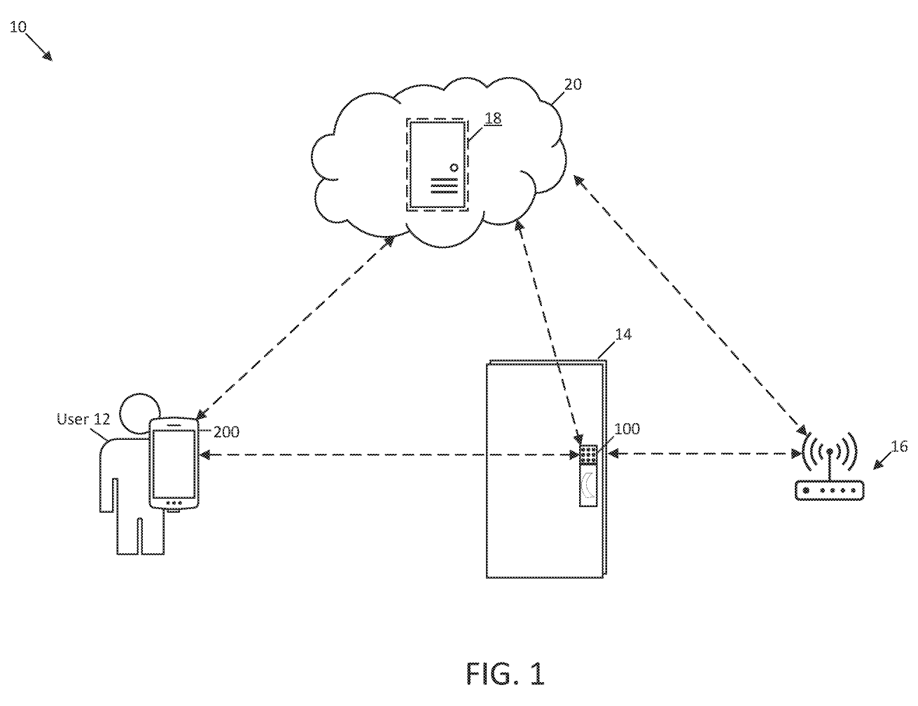

FIG. 1 illustrates an environment 10 in which aspects of the present disclosure may be implemented. The environment 10 includes a user 12, a mobile device 200, a door 14, a lockset 100, a wireless router 16, and a server 18.

The user 12 may interact with the lockset 100 to, for example, install the lockset 100, actuate a locking mechanism, check a status of the lock, update a lock setting, or perform another operation related to the lockset. In some instances, the user 12 may be registered with the lockset 100 or may otherwise be authorized to actuate the lockset 100, such as an owner or tenant of the premises where the door 14 comprising the lockset 100 is installed. In some instances, the user 12 may have a code that he or she may enter at a keypad of the lockset 100 to actuate the locking mechanism, either in addition to or to the exclusion of the user being otherwise registered or authorized at the electronic lock (e.g., via connectivity between a mobile device of the user and the electronic lock).

The door 14 may be an interior or exterior door installed at a premises. Described below are non-limiting examples of a wireless electronic lockset mounted to the door 14. It should be noted that the lockset 100 may be used on other types of doors, such as a garage door, garden shed door, lockbox door, sliding door, doggie door, or other types of doors that require an authentication process to unlock (or lock) the door.

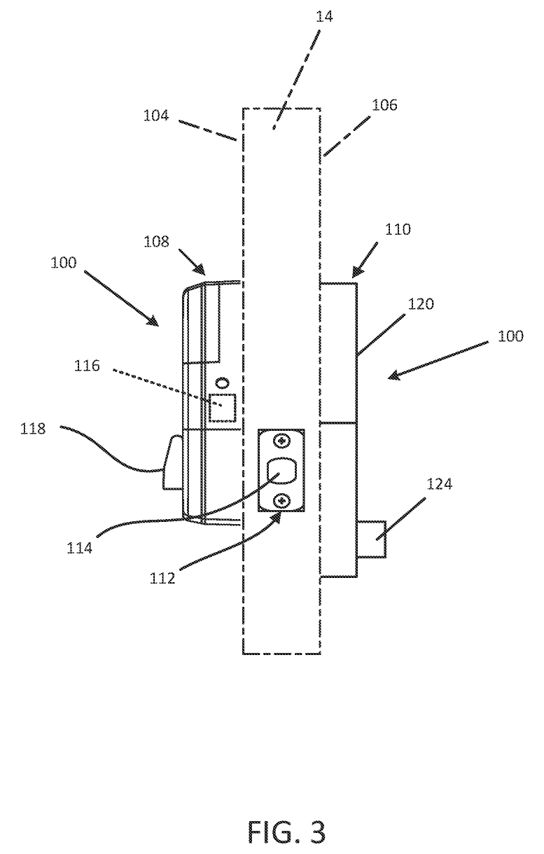

The lockset 100 may be an electronic lockset that is configured to lock and unlock the door 14. In some embodiments, the lockset 100 may be configured to operate with both left-handed and right-handed doors. For example, the lockset 100 may include a motor that is actuated to extend and retract a bolt. Thus, to operate properly, the lockset 100 may determine handing of the door 14 to properly lock and unlock the door 14. In some embodiments, the lockset 100 may include one or more sensors to determine handing of the door 14, as is further described below. In some embodiments, the lockset 100 may include wireless communication capabilities. For example, the lockset 100 may include components for communicating with the user 12. As described herein, the lockset 100 may include not only components configured to actuate a bolt, but may also include components that are coupled, either directly or indirectly, and either mechanically or electrically, with components for actuating the bolt. For example, as described further in connection with FIGS. 3-5, the electronic lockset 100 may include housings and components coupled to housings, a handle, a keyway, a keypad, sensors, and other components depicted in FIGS. 3-5.

The user 12 may be associated with the mobile device 200. For example, the user 12 may carry the mobile device 200 or be the owner of the mobile device 200. The mobile device 200 may be a device with wireless communication capabilities, such as a smartphone, tablet, or key fob. The mobile device 200 may be capable of communicating with the lockset 100, communicating with the server 18, communicating with other mobile devices, and communicating with the router 16. The mobile device 200 may have a mobile application installed thereon that is associated with the lockset 100 or the server 18. The mobile device 200 may include a web browser for accessing a program to communicate with the lockset 100 or the server 18. The mobile device 200 may include a camera and an application for analyzing images captured by the camera.

In example embodiments, the router 16 may be a Wi-Fi router. In some embodiments, the router 16 may be located within the premises or building to which the door 14 is attached. The router 16 may be capable of communicating with the lockset 100, and the router 16 may be capable of communicating with the server 18. The router 16 may route communications between the server 18 and the lockset 100. In some embodiments, the router may be a hub for Internet of Things (IoT) devices. In some embodiments, the lockset 100 and the router 16 may be coupled via a mesh network. For instance, communication between the lockset 100 and the router 16 may be passed through one or more other devices.

The server 18 can be, for example, a physical server or a virtual server hosted on a cloud platform 20. In examples, the cloud platform 20 may be a multi-cloud platform, a private cloud, a public cloud, or a hybrid cloud. In some embodiments, the server 18 may include a cluster of servers or nodes. In some embodiments, the lockset 100 is also capable of communicating with the server 18. Such communication can optionally occur via one or more wireless communication protocols, e.g., Wi-Fi (IEEE 802.11), short-range wireless communication to a Wi-Fi bridge, or other connection mechanism. According to an embodiment, the server 18 may create and store an account associated with one or more of the lockset 100, the user 12, the mobile device 200, the router 16, the door 14, or the building on which the door 14 is installed. In some embodiments, the server 18 may create or store credentials for one or more of the accounts.

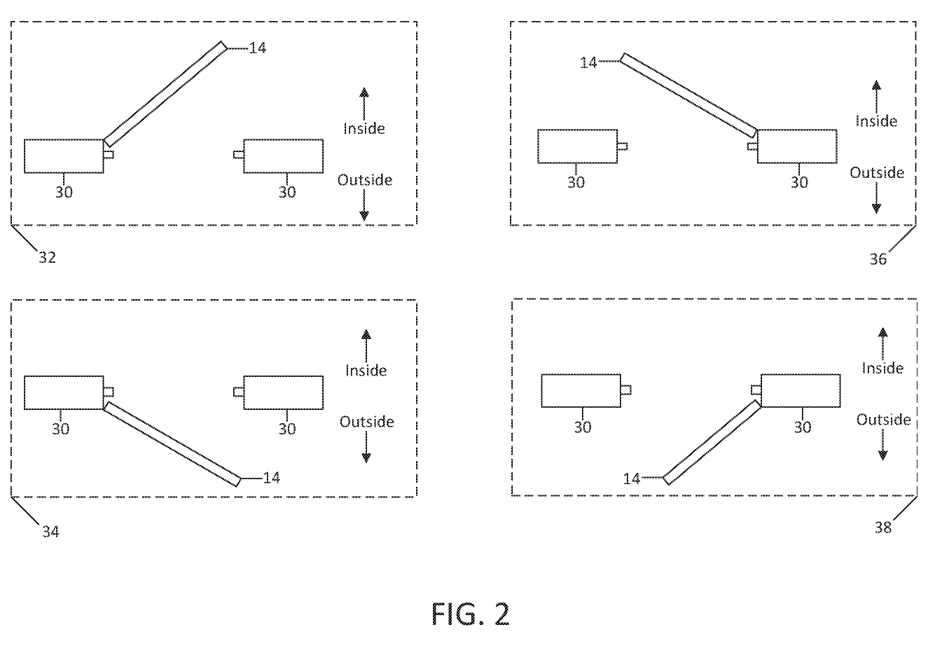

FIG. 2 illustrates example configurations 32–38 of the door 14. In each of the example configurations 32–38, the door 14 is installed on the walls 30, which may form part of the premises to which the door 14 is attached. For each example configuration 32–38, an outside side of the walls 30 and an inside side of the walls 30 is depicted. Though not illustrated in the example of FIG. 2, the lockset 100 may be installed on the door 14 in each of the example configurations 32–32.

In the example configuration 32, the door 14 is an in-swinging, left-handed configuration. In the example configuration 34, the door 14 is in an out-swinging, left-handed configuration. In the example configuration 36, the door is in an in-swinging, right-handed configuration. In the example configuration 38, the door is in an out-swinging, right-handed configuration. In some embodiments, however, the example configurations 32–34 may be considered as right-handed doors, and the example configurations 36–38 may be considered as left-handed doors. For example, in some instances, door professionals, lock professionals, and users may use different classifications for door handing depending on their task. However, it should be noted that aspects of the present disclosure may be compatible with any system for classifying door handing.

In some embodiments, the lockset 100 may be configured to extend a lock in a direction that is based on the handing of the door 14. For example, for a left-handed door, the lockset 100 may be configured to extend a bolt to the right to lock the door, whereas for a right-handed door, the lockset 100 may be configured to extend a bolt to the left to lock the door. Depending on a direction that the bolt is to be extended, the operations of a motor may vary (e.g., whether the motor is to cause a drive shaft to rotate in a clockwise direction or a counterclockwise direction). Thus, for a lock configured to be installable on both right-handed and left-handed doors, the handing of the door may be determined prior to the lock functioning properly. Among other things, aspects of the present disclosure describe various techniques for automatically detecting door handing to enable proper functioning of the lockset 100.

FIG. 3 illustrates a lockset 100 as installed at a door 14, according to one example of the present disclosure. The door 14 has an interior side 104 and an exterior side 106. The lockset 100 includes an interior assembly 108, an exterior assembly 110, and a latch assembly 112. The latch assembly 112 is shown to include a bolt 114 that is movable between an extended position (locked) and a retracted position (unlocked, shown in FIGS. 3–6). Specifically, the bolt 114 is configured to slide longitudinally and, when the bolt 114 is retracted, the door 14 is in an unlocked state. When the bolt 114 is extended, the bolt 114 protrudes from the door 14 into a doorjamb to place the door in a locked state. In examples, a processor of the lockset 100 may use a motor to actuate the bolt 114.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term "outside" is broadly used to mean an area outside the door 14 and "inside" is broadly used to denote an area inside the door 14. With an exterior entry door, for example, the exterior assembly 110 may be mounted outside a building, while the interior assembly 108 may be mounted inside a building. With an interior door, the exterior assembly 110 may be mounted inside a building, but outside a room secured by the lockset 100, and the interior assembly 108 may be mounted inside the secured room. The lockset 100 is applicable to both interior and exterior doors.

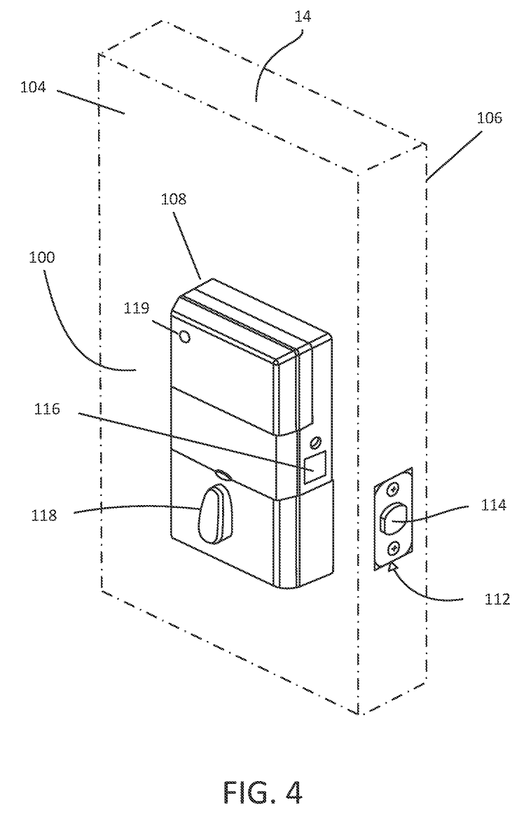

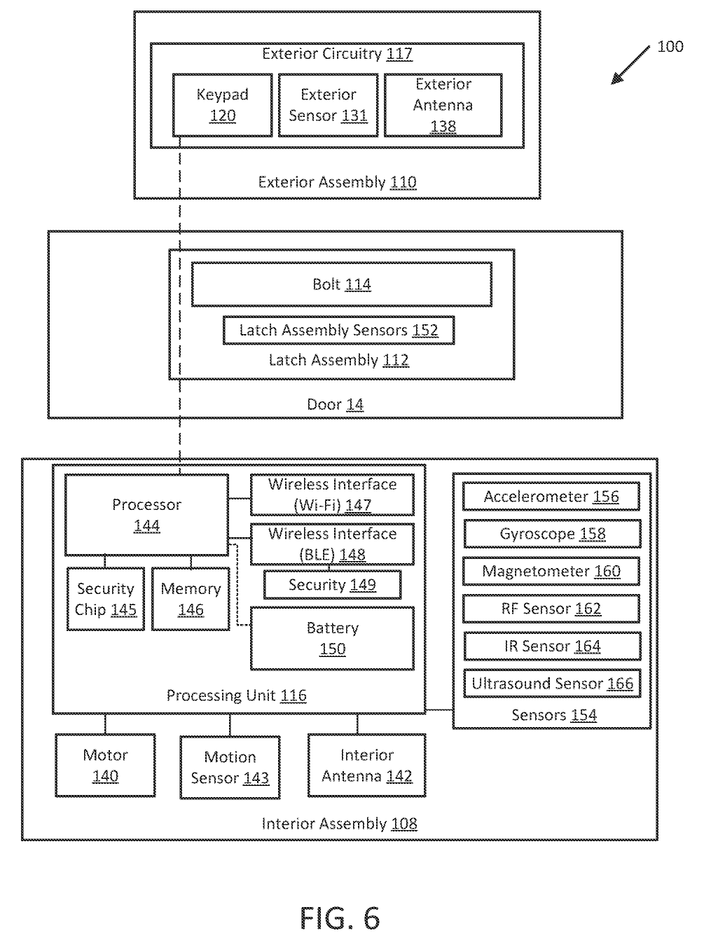

FIG. 4 illustrates a perspective view of the lockset 100 from an interior of the door 14. In some embodiments, the interior assembly 108 can include a processing unit 116 (shown schematically in FIG. 6) containing electronic circuitry for the lockset 100. In some examples, the interior assembly 108 includes a manual turn piece 118 that can be used on the interior side 104 of door 14 to move the bolt 114 between the extended and retracted positions. The processing unit 116 is operable to execute a plurality of software instructions (e.g., firmware) that, when executed by the processing unit 116, cause the lockset 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the lockset 100. The processing unit 116 may include memory communicatively interfaced to the processor for storing the software instructions. Alternatively, the lockset 100 may further comprise a separate memory device for storing the software instructions that is electrically connected to the processing unit 116 for the bi-directional communication of the instructions, data, and signals therebetween.

In some examples, the interior assembly 108 includes a pairing button 119 (shown schematically), which when actuated, initiates a pairing mode for a connection over an interface. For example, the pairing mode may enable the lockset 100 to communicate with a mobile device (e.g., the mobile device 200) within wireless communication range for enabling the mobile device to be paired with the lockset 100. In some embodiments, once the lockset 100 is paired with the mobile device, the mobile device may be used as part of installing the lockset 100. In other embodiments, the mobile device 200 need not be paired with the lockset 100 to execute aspects of an installation process for the lockset 100. As can be appreciated, initiating the pairing mode via an actuation of the pairing button 119 may be limited to users who have access to the interior side 104 of the door 14. In some embodiments, the lockset 100 may be coupled with a mobile device without use of the pairing button 119. For instance, pairing may be performed by communicating with the server 18, or one or more of the mobile device 200 or the lockset 100 may broadcast a signal for pairing.

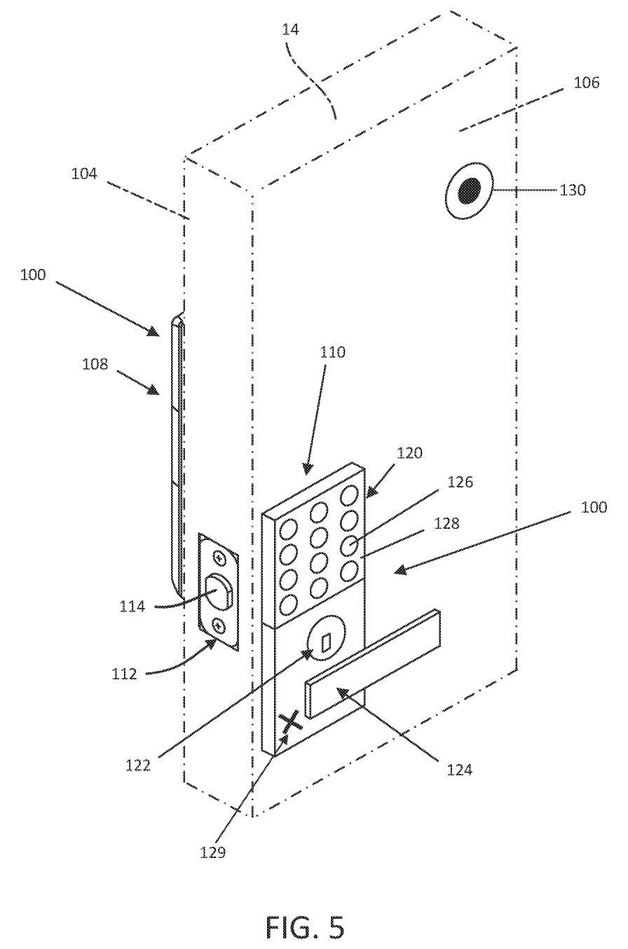

FIG. 5 illustrates a perspective view of the lockset 100 from an exterior of the door 14. The exterior assembly 110 can include exterior circuitry communicatively and electrically connected to the processing unit 116. For example, the exterior assembly 110 may include exterior circuitry, which may include one or more electrical components. In some embodiments, the exterior circuitry 117 may include a keypad 120 for receiving a user input and/or a keyway 122 for receiving a key. The exterior side 106 of the door 14 can also include a handle 124. In some examples, the exterior assembly 110 includes the keypad 120 and not the keyway 122. In some examples, the exterior assembly 110 includes the keyway 122 and not the keypad 120. In some examples, the exterior assembly 110 includes the keyway 122 and the keypad 120. When a valid key is inserted into the keyway 122, the valid key can move the bolt 114 between the extended and retracted positions.

When a user inputs a valid actuation passcode into the keypad 120, the bolt 114 may be moved between the extended and retracted positions. In some examples, the exterior assembly 110 is electrically connected to the interior assembly 108. Specifically, in some examples, the keypad 120 may be electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of latch assembly 112, thus permitting door 14 to be opened from a closed position. Still further, an electrical connection between the exterior assembly 110 and the interior assembly 108 allows the processing unit 116 to communicate with other features included in the exterior assembly 110, as noted below.

The keypad 120 can be any of a variety of different types of keypads. The keypad 120 can be one of a numeric keypad, an alpha keypad, and/or an alphanumeric keypad. The keypad 120 can have a plurality of characters displayed thereon. For example, the keypad 120 can include a plurality of buttons 126 that can be mechanically actuated by the user (e.g., physically pressed).

In some embodiments, one or more lights associated with one or more buttons of the keypad may be activated (e.g., illuminated) during installation of the lockset 100. Such illumination may, in some embodiments, be used as part of automatically determining handing of the door 14. For example, an image processing application may detect a location of the lockset 100 based at least in part on identifying a light associated with the keypad 120. In some embodiments, the lights may signal a numeric code associated with the lockset 100. As an example, the buttons “1,” “4,” “5,” and “9,” could be illuminated during installation of the lockset 100, and an installation program (e.g., of the mobile device 200 or the server 18) may identify the lockset 100 by using the numbers “1,” “4,” “5,” and “9”. In some embodiments, one or more of the lights associated with the buttons may have a color (e.g., the “9” button could be lit up as either blue, green, or red), thereby increasing the number of unique codes that may be transmitted by the lockset 100 by using the one or more lights associated with the one or more buttons 126.

In some examples, the keypad 120 includes a touch interface 128, such as a touch screen or a touch keypad, for receiving a user input. The touch interface 128 is configured to detect a user's "press of a button" by contact without the need for pressure or mechanical actuation. In some embodiments, interacting with the keypad 120 may cause an electrical component of the lockset 100 to be activated (e.g., may cause a switch to close), which may allow the user to actuate the bolt 114 using the keypad 120.

In alternative embodiments, one or more other types of user interface devices can be incorporated into the lockset 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

In some embodiments, the lockset 100 may be coupled to a camera 130. In some embodiments, the camera 130 may be disposed on the exterior side 106 of the door 14. In some embodiments, the camera 130 may be activated by a processing unit of the lockset 100. In some embodiments, the camera 130 may detect movement (e.g., a user approaching the door 14). In response to detecting movement, the camera 130 may provide a signal to the lockset 100, thereby activating or deactivating a component of the lockset 100. In some embodiments, the camera 130 may be used to during an installation process of the lockset 100. For example, the camera 130 may capture an image or video of an area around the door 14 or the lockset 100 to determine a location of the lockset 100 on the door 14. In some embodiments, by using the image or video captured by the camera 130, a handing of the door 14 may be determined, as is further described below. In some embodiments, the camera 130 may be disposed on the interior side 104 of the door 14.

In some embodiments, indicia 129 may be displayed on the exterior assembly 110. The indicia 129 may be a mark that may be used by an image processing application to identify a location of the lockset 100. For example, an image processing application may be trained to recognize the indicia 129. Thus, when the image analysis program analyzes an image of the lockset 100, the program may recognize the indicia 129 and thereby recognize, in some embodiments, a location of the lockset 100 on the door 14. The indicia 129 may be any marking. In the example shown, the indicia 129 is an “X”. However, the indicia 129 may be a logo, a word, a color, a stamp, a barcode, a QR code, or another mark or feature on the lockset 100. In some embodiments (e.g., when the indicia 129 is a barcode, a QR code, or an alphanumeric string), the image processing application may determine an identifier associated with the lockset 100 by using the indicia 129. In some embodiments, the indicia 129 may be on the interior assembly 108 instead of or in addition to the exterior assembly 110. In some embodiments, the indicia 129 may be located on the door 14 or near the door 14 without being on the lockset 100.

FIG. 6 illustrates schematic representations of embodiments of the lockset 100 mounted to the door 14. Examples of the interior assembly 108, the exterior assembly 110, and the latch assembly 112 are shown. In other embodiments, the lockset 100 may include more or fewer components than those illustrated in connection with the FIG. 6. In some embodiments, the lockset 100 may include an electrical circuit that connects one or more components of the lockset 100 described herein. In examples, the electrical circuit may receive power from a battery 150 or from a different power source. In some embodiments, the lockset 100 may include a plurality of subcircuits, each of which may include one or more components of the lockset 100 described herein, and the subcircuits may, in some embodiments, allow the lockset 100 to selectively activate or deactivate only some electrical components.

The exterior assembly 110 is shown to include the keypad 120 and an exterior antenna 138 usable for communication with a remote device. In addition, the exterior assembly 110 can include one or more sensors 131, such as a camera, proximity sensor, button, or other mechanism by which conditions exterior to the door 14 can be sensed. In response to such sensed conditions, notifications may be sent by the lockset 100 to a server 18 or mobile device 200 including information associated with a sensed event (e.g., time and description of the sensed event, or remote feed of sensor data obtained via the sensor).

The exterior antenna 138 is capable of being used in conjunction with an interior antenna 142, such that the processing unit 116 can determine where a mobile device is located. In some embodiments, only a mobile device (e.g., the mobile device 200) that is paired with the lockset 100 and determined to be located on the exterior of the door 14 is able to actuate (unlock or lock) the door. This prevents unauthorized users from being located exterior to the door 14 of the lockset 100 and taking advantage of an authorized mobile device that may be located on the interior of the door, even though that authorized mobile device is not being used to actuate the door. In alternative arrangements, the lockset 100 is only actuatable from either the keypad 120 (via entry of a valid actuation passcode) or from an application installed on a mobile device.

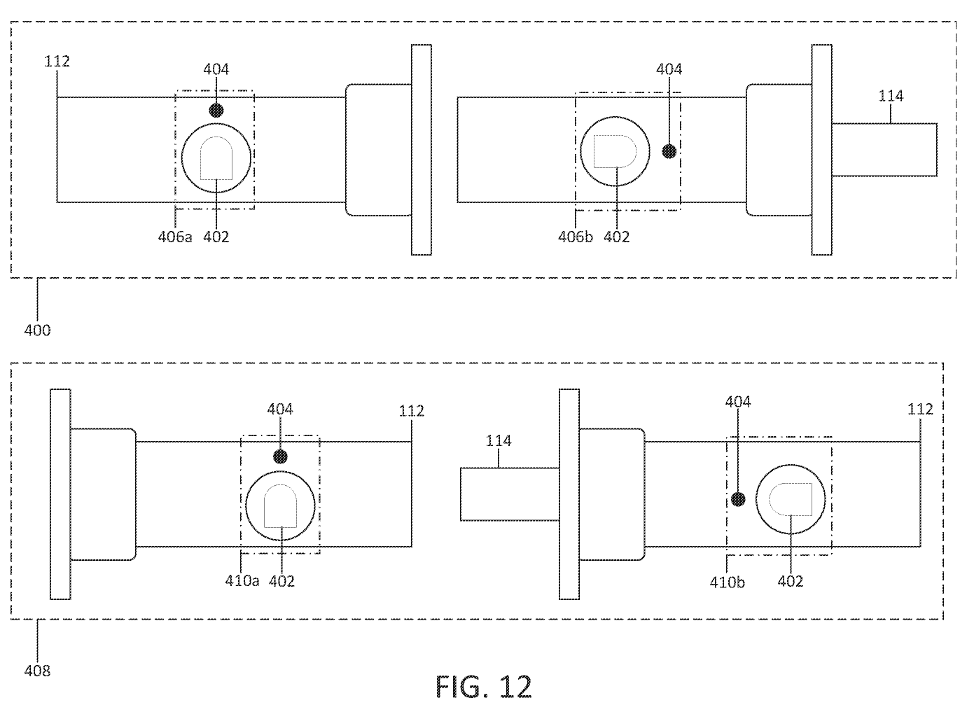

As described above, the latch assembly 112 may include the bolt 114. To extend and retract the bolt 114, the latch assembly 112 may include a drive shaft that is operationally coupled with a motor 140 and the bolt 114. In some embodiments, the drive shaft may rotate in a first direction to extend the bolt and a second direction to retract the bolt. In some embodiments, the latch assembly 112 may include one or more latch assembly sensors 152 to detect a rotation of the drive shaft or to detect an element that is rotationally coupled with the drive shaft. The latch assembly sensors 152 may, in some embodiments, be one or more magnetometers, and the drive shaft may be rotationally coupled with a magnet. In some embodiments, the one or more latch assembly sensors 152 may be used to determine a handing of the door 14, as described below in connection with FIGS. 12–14.

As described above, the interior assembly 108 includes the processing unit 116. The interior assembly 108 can also include a motor 140, a motion sensor 143, and an interior antenna 142. As shown, the processing unit 116 includes at least one processor 144 communicatively connected to a security chip 145, a memory 146, various wireless network interfaces, a security application 149, and a battery 150. For example, the processing unit 116 may include a network interface for communicating via the IEEE 802.11 standard (Wi-Fi®), the IEEE 802.15.4 standard (Zigbee®, Z-Wave®, and Thread), the IEEE 802.15.1 standard (Bluetooth®), or another standard. In some embodiments the Bluetooth interface 148 may be configured to communicate via a Bluetooth Low Energy (BLE) protocol. In some embodiments, a network interface for communicating via other communication protocols may—instead of, or in addition to, the Wi-Fi interface 147 and the BLE interface 148—be present. For example, the electronic lockset 100 may include a network interface for communicating according to one or more of the following protocols: Thread, Matter, near-field communication (NFC), Z-Wave, ZigBee, Narrow Band IoT (NB-IoT), LoRa, 3G, LTE, 4G, 5G or another protocol or network. The processing unit 116 is located within the interior assembly 108 and is capable of operating the lockset 100, e.g., by actuating a motor 140 to actuate the bolt 114.

In some examples, the processor 144 can process signals received from a variety of devices to determine whether the lockset 100 should be actuated. Such processing can be based on a set of preprogramed instructions (i.e., firmware) stored in the memory 146. In certain embodiments, the processing unit 116 can include a plurality of processors 144, including one or more general purpose or specific purpose instruction processors. In some examples, the processing unit 116 is configured to capture a keypad input event from a user and store the keypad input event in the memory 146. In other examples, the processor 144 receives a signal from the exterior antenna 138, the interior antenna 142, or a motion sensor 143 (e.g., a vibration sensor, gyroscope, accelerometer, motion/position sensor, or combination thereof) and can validate received signals in order to actuate the lock 100. In still other examples, the processor 144 receives signals from one or more network interfaces to determine whether to actuate the lockset 100.

In some embodiments, the processing unit 116 may be communicatively coupled with a plurality of sensors 152, 154. One or more of the sensors 152, 154 may be used as part of determining a handing of the door 14. For example, sensor 152 may detect a bolt position, and may be positioned to directly sense a position of the bolt or may sense a rotational position of a component within the interior assembly 108. In the example shown, the sensors 154 include an accelerometer 156, a gyroscope 158, a magnetometer 160, a radio frequency sensor 162, an infrared sensor 162, and an ultrasound sensor 166.

In example embodiments, the number and types of sensors in the sensors 154 may vary depending on the embodiment. For example, the sensors 154 may include the accelerometer 156, gyroscope 158, and magnetometer 160, and may be combined as part of an inertial measurement unit. Additionally, the sensors 154 may include more or fewer sensors than those illustrated in the example of FIG. 6. Furthermore, one or more of the sensors may be combined.

Furthermore, although illustrated as part of the interior assembly 108, one or more of the sensors 152, 154 may be positioned in a different component of the lockset 100 or may be positioned external to the lockset 100. For example, the sensors 152 may be positioned within the interior assembly 108, while one or more of the sensors 154 may be positioned at a location other than within the interior assembly 108 (e.g., within the exterior assembly 110 or latch assembly 112). Additionally, the plurality of sensors 154 may be positioned within the interior assembly 108. In alternative embodiments, one or more such sensors may be positioned within the exterior assembly 110, or the latch assembly 112.

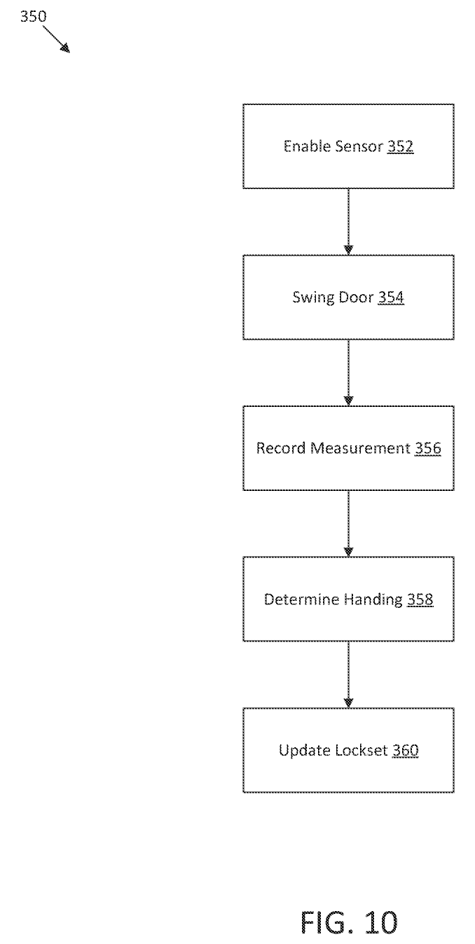

As discussed below in connection with FIGS. 10–16, one or more of the sensors 154 may be used as part of determining a handing of the door 14. Generally speaking, for sensors detecting motion, because those sensors are positioned in known constant locations within an interior or exterior assembly, motion of the lockset 100 while installed on a door will allow such sensors, and the processing unit 116, to determine a direction of swing of a door. The direction of swing of the door can be used to determine a direction toward which a bolt would be moved to be in an extended or retracted position, thereby allowing for an automated handing process to occur in accordance with the example embodiments described herein.

In some embodiments, the processing unit 116 includes a security chip 145 that is communicatively interconnected with one or more instances of processor 144. The security chip 145 can, for example, generate and store cryptographic information usable to generate a certificate usable to validate the lockset 100 with a remote system, such as the server 18 or mobile device (e.g., the mobile device 200). In certain embodiments, the security chip 145 includes a one-time write function in which a portion of memory of the security chip 145 can be written only once and then locked. Such memory can be used, for example, to store cryptographic information derived from characteristics of the lockset 100, or its communication channels with server 18 or one or more mobile devices 200. Accordingly, once written, such cryptographic information can be used in a certificate generation process which ensures that, if any of the characteristics reflected in the cryptographic information are changed, the certificate that is generated by the security chip 145 would become invalid, and thereby render the lockset 100 unable to perform various functions, such as communicate with the server 18 or mobile device 200, or operate at all, in some cases.

In some embodiments, the security chip 145 may be configured to generate a pairing passcode that, when entered using the keypad 120 of the lockset 100, triggers a pairing mode of one or more of the network interfaces of the lockset 100 that enables the lockset 100 to pair with a proximate mobile device. In some embodiments, a pairing passcode may be used to pair with a proximate mobile device. In some examples, the pairing passcode is provided to the user 12 upon initial setup/activation of the lockset 100 (e.g., via an electronic lock application associated with the lockset 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or administrative user-selected time duration. In further examples, a digit of the pairing passcode may correspond to a setting that may instruct the lockset 100 to perform one or more of: disable the pairing passcode after it has been used; keep the pairing passcode enabled after it has been used; or reset the pairing passcode to a new random value after it has been used.

The memory 146 can include any of a variety of memory devices, such as using various types of computer-readable or computer storage media. A computer storage medium or computer-readable medium may be any medium that can store a program or instructions for performing one or more operations, steps, or methods described herein. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices.

Computer storage media can, in some examples, include embodiments including entirely non-transitory components. In some embodiments, the processor 144 may execute programs or instructions stored by the memory 146. In some embodiments, the memory 146 may store one or more codes that may be input by a user to actuate the bolt 114. For instance, a user may input a code into the keypad 120, or the mobile device 200 may provide a code to the lockset 100 via a network interface. To validate the code, the processor 144 may compare the input code to the one or more codes stored in the memory 146. In some embodiments, the memory 146 may store data that indicates a handing of the door 14, or the memory 146 may store data that indicates that the handing for the door 14 has not yet been determined. In some embodiments, the processor 144 may use the data indicating a handing of the door 14 as part of actuating the motor 140 to control movement of the bolt 114.

As noted above, the processing unit 116 can include one or more wireless interfaces, such as Wi-Fi interface 147, a Bluetooth interface 148, and/or another interface. Other RF circuits can be included as well. In the example shown, the interfaces 147, 148 are capable of communication using at least one wireless communication protocol. In some examples, the processing unit 116 can communicate with a remote device, such as the server 18, via a first network interface (e.g., the Wi-Fi interface 147) and with a proximate device, such as the mobile device 200, via a second network interface (e.g., the interface 148). In some embodiments, the processing unit 116 is configured to communicate with the mobile device 200 via a short-range wireless interface, such as a network interface configured to communicate using a protocol for any one or more of BLE, NFC, Thread, or another protocol. When the mobile device 200 is out of range of such network, the mobile device 200 may communicate with the server 18, which may relay communications to the lockset 100. In some embodiments, the lockset 100 may use the Wi-Fi interface 147 to communicate with the server 18. In other embodiments, the lockset 100 may communicate with a hub device or router device using a different network protocol (e.g., BLE, NFC, Thread), and the hub device or router may route communications between the server 18 and the lockset 100.

The interior assembly 108 also includes the battery 150 to power the lockset 100. In some embodiments, the lockset 100 may include a plurality of batteries, or the lockset 100 may also include other power sources. In one example, the battery 150 may be a standard single-use (disposable) battery.

The interior assembly 108 also includes the motor 140 that is capable of actuating the bolt 114. In use, the motor 140 receives an actuation command from the processing unit 116, which causes the motor 140 to actuate the bolt 114 from the locked position to the unlocked position or from the unlocked position to the locked position. In some examples, the motor 140 actuates the bolt 114 to an opposing state. In some examples, the motor 140 receives a specified lock or unlock command, where the motor 140 only actuates the bolt 114 if the bolt 114 is in the correct position. For example, if the door 14 is locked and the motor 140 receives a lock command, then no action is taken. If the door 14 is locked and the motor 140 receives an unlock command, then the motor 140 actuates the bolt 114 to unlock the door 14. In some embodiments, the operation of the motor 140 to actuate the bolt 114 may depend at least in part on the handing of the door 14. In some embodiments, a mechanism other than the motor 140 may be used to electrically actuate the bolt 114, such as magnets or solenoids.

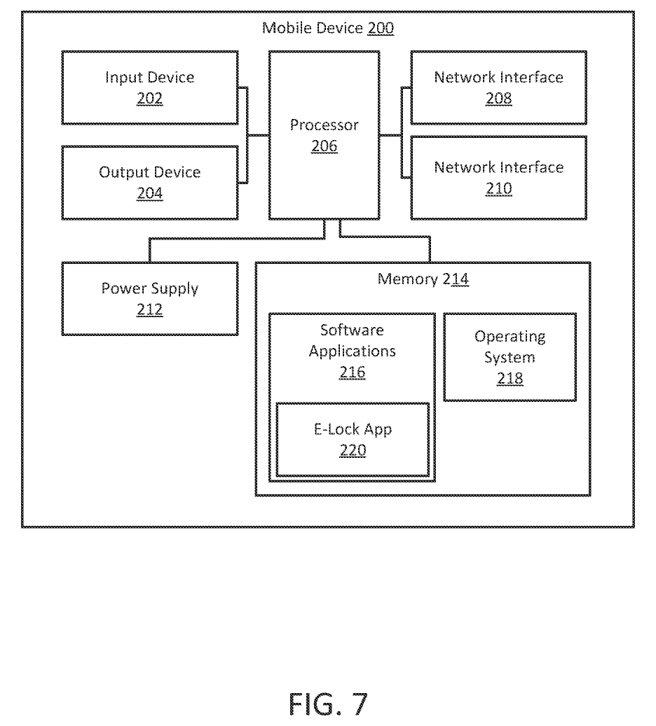

FIG. 7 illustrates a schematic diagram of a mobile device, such as the mobile device 200, usable in embodiments of the present disclosure. In some embodiments, the mobile device 200 operates to form a connection with a network-enabled security device such as the lockset 100. In some embodiments, the mobile device 200 may communicate with the server 18 via a Wi-Fi or mobile data connection. Thus, in some embodiments, the mobile device 200 can operate to communicate information between the lockset 100 and the server 18. The mobile device 200 shown in FIG. 7 includes an input device 202, an output device 204, a processor 206, a first network interface 208, a second network interface 210, a power supply 212, and a memory 214. In some embodiments, the first network interface 208 may be a Wi-Fi interface, and the second network interface 210 may be a Bluetooth interface. In some embodiments, the mobile device 200 may include an interface to communicate via a cellular network, a Thread protocol, near-field communication protocol, or another protocol or network type.

The input device 202 operates to receive input from external sources. Such sources can include inputs received from a user (e.g., the user 12). The inputs can be received through a touchscreen, a stylus, or keyboard. In some embodiments, the input device may be a microphone, and the mobile device 200 may receive a voice input. In some embodiments, the input device is a camera, and the mobile device may receive an image input or a video input via the camera.

The output device 204 operates to provide output of information from the mobile device 200. For example, a display can output visual information while a speaker can output audio information.

The processor 206 reads data and instructions. The data and instructions can be stored locally, received from an external source, or accessed from removable media. In some examples, the first network interface 208 is similar to the Wi-Fi interface 147. In some embodiments, a Wi-Fi connection may be established between the mobile deice 200 and the server 18. In some embodiments, a connection via a cellular network may be established between the mobile device 200 and the server 18. In some embodiments, the second network interface 210 is similar to the Bluetooth interface 148. In some examples, a Bluetooth connection may be established between the mobile device 200 and the lockset 100. In some embodiments, a connection according to an NFC protocol, Thread protocol, or other protocol may be established between the mobile device 200 and the lockset 100.

The power supply 212 provides power to the processor 206. The memory 214 includes software applications 216 and an operating system 218. The memory 214 contains data and instructions that are usable by the processor to implement various functions of the mobile device 200.

The software applications 216 can include applications usable to perform various functions on the mobile device 200. One such application is an electronic lock application 220. In some embodiments, the electronic lock application 220 may be used to interact with the lockset 100. In some embodiments, the electronic lock application 220 may be used to interact with the server 18. In some embodiments, the electronic lock application 220 may be used as part of installing the lockset 100. For example, as described below, the electronic lock application 220 may be used to determining a handing of the door 14. In some embodiments, the electronic lock application 220 includes an image processing application that may analyze an image to determine a handing of the door. In other embodiments, the mobile device 200 may include more or fewer components than those illustrated in the example of FIG. 7.

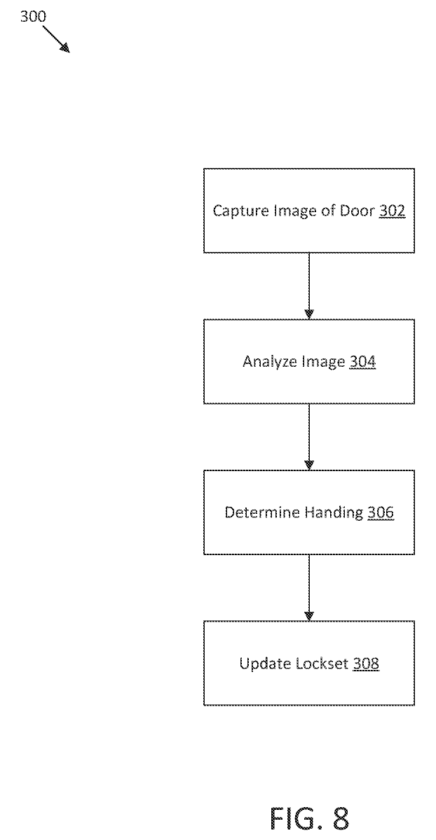

FIGS. 8–16 illustrate techniques for determining handing of a door. Although discussed in the context of determining handing for a door with a lockset installed thereon (e.g., in the context of the door 14 and the lockset 100), the techniques described herein may be applied to determine handing for other doors and locksets as well. Additionally, for a given door, more than one technique for determining handing may be applied (e.g., the handing for a door may be determined in a first manner and then verified in a second manner), or a technique for determining handing for a door may be repeated to update a door’s handing (e.g., in case of a mistake or a reinstallation of the door). In some embodiments, one or more of the techniques for determining handing may be part of a lock installation process and may be performed when determining other lockset characteristics, such as determining whether the lockset is in a locked or unlocked state. In some embodiments, techniques described herein may be performed during regular usage of the lockset 100 or the door 14 (e.g., the lockset 100 may determine that handing is to be determined without explicitly notifying the user of a handing determination during an installation process).

FIG. 8 is a flowchart of an example method 300 for determining handing of the door 14 using an image.

In the example shown, an image of the door may be captured (step 302). In one embodiment, the user 12 may use the mobile device 200 to capture an image of the door 14 with the lockset 100 mounted thereon. In some embodiments, the image may be of an exterior of the door, whereas in other embodiments, the image may be of the interior of the door. In some embodiments, the user 12 may indicate, for example using the mobile application 220 whether an image of the interior or exterior of the door is being captured, whereas in other embodiments, the user 12 need not indicate whether an interior or exterior of the door is being captured, because such information may be derived based on characteristics of the image (e.g., identifying a keypad, a manual turn piece, or another feature that is characteristic of either an interior or exterior of the lockset 100). In some embodiments, the image of the door may be captured with a different camera than the camera of the mobile device 200. For example, in some embodiments, a camera coupled with the lockset 100 may capture an image of the door 14. In some embodiments, the user 12 may be prompted to capture the image of the door 14 by the mobile application 220.

In the example shown, the image of the door 14 may be analyzed (step 304). In some embodiments, an image processing application may analyze the image. In some embodiments, the image processing application executes a computer vision algorithm to analyze the image and detect objects in the image. In some embodiments, the image processing application may include a machine learning model that is trained to recognize objects. For example, the machine learning model may be trained to recognize a location of a door within an image, including one or more edges of the door. Furthermore, the machine learning model may be trained to recognize a lockset mounted to the door. As a result, the image processing application may determine a relative location of the lockset 100 on the door 14. Furthermore, in some embodiments, the image processing application may determine whether the image includes an interior or exterior of the door 14, thereby eliminating the need to ask a user to specify which side of the data is being photographed and thereby allowing a user to capture an image of either side. In some embodiments, the image processing application is developed using one or more of ARKit, OpenCV, or another platform for developing an image processing program.

In some embodiments, to determine a location of the lockset 100 in the image, the image processing application may identify a characteristic of the lockset, such as the indicia 129, keypad 120, keyway 122, handle 124, turn piece 118, or other element of the lockset 100. For example, the machine learning model may detect an illumination of the keypad 120, a location of the indicia, or the location of another object. In some embodiments, the image processing application may also detect objects in the image that are near the door 14 or the lockset 100, such as hinges, door jambs, strike plates, door frames, lights, windows, decorations, an extended bolt, or other objects. In some embodiments, the image processing application may, after identifying the door 14, analyze a limited number of locations on the door 14 to identify the lockset 100, given that it may be known that there are a limited possible number of locations at which the lockset 100 may be installed (e.g., near the edges of a door). As a result, the latency required to analyze the image to identify a location of the lockset 100 may, in some instances be reduced as compared to a process in which the entire image is analyzed to identify a location of the lockset 100.

Additionally, in some embodiments, the image processing application may be configured to detect an identifier of the lockset 100. For example, as described above, the buttons 126 of the keypad 120 may be selectively illuminated to display a pattern, identifier, or code associated with the lockset 100. As another example, the indicia 129 may include or be associated with an identifier of the lockset 100. In some embodiments, a machine learning model of the image processing application may recognize or derive an identifier associated with the lockset 100 from the keypad 120, the indicia 129, or from other data in the analyzed image. In some embodiments, the mobile application 220 or the server 18 may use the identifier of the lockset 100 to properly select the lockset 100 from a plurality of possible locksets. For example, the server 18 may be associated with a plurality of locksets. Based on the identifier associated with the lockset 100, the lockset 100 may be accurately selected from the plurality of locksets and an update regarding handing may be correctly provided to the lockset 100.

The location at which the image is processed may vary. For example, in some instances, the mobile device 200 may capture the image, and the image processing application may analyze the image at the mobile device 200. In other embodiments, the mobile device 200 may capture the image and provide the image to the server 18, where the image processing application may analyze the image. In other embodiments, the mobile device 200 or another camera (e.g., the camera 130) may capture the image and provide the image to the lockset 100, where the image processing application may process the image. In other embodiments, the mobile device 200 or another camera may capture the image and provide it to a hub device (e.g., the hub of an IoT network) to be analyzed. In some embodiments, once the image is analyzed and the handing of the door 14 is determined, the image is discarded to protect user privacy.

In the example shown, the handing of the door may be determined based on the analysis of the image (step 306). In some embodiments, the handing may be determined based on the location of the lockset 100 on the door 14. For example, the image processing application may determine that the lockset 100 is closer to a right-side edge of a door than a left-side edge of a door. As a result, it may be determined that the door 14 is left-handed and that, to lock the door 14, the lockset 100 may extend the bolt 114 to the right. In some embodiments, determining the handing of the door 14 may account for whether the image is captured from the interior or exterior of the door 14. For example, if the image is captured from the interior, then a first set of rules may be applied, and if the image is captured from the exterior, then a converse of the first set of rules may be applied. As another example, the door handing may be determined by using other objects recognized in the analyzed objects. For instance, if the door hinges are identified as being on the left-hand side of the lockset 100, then the door 14 may be a left-handed door. As another example, in response to detecting that the bolt 114 is extended on a right-hand side of the door 14, it may be determined that the door is left-handed. As another example, the door handing may be determined based on a location of the lockset 100 relative to a door frame, door jamb, strike, plate, or other object.

In some embodiments, the door handing may be inferred without exclusively relying on the relative location of the lockset 100. For example, a machine learning model may be trained to classify door images as either left- handed or right-handed using supervised, semi-supervised, or unsupervised machine learning techniques. Thus, when the image processing application analyzes the image of the door 14, it may infer whether the door 14 is left-handed or right-handed without explicitly depending on the location of any particular object in the image, but rather may classify the door as left-handed or right-handed based on learned weights from machine learning training process.

In some embodiments, analyzing the image and determining the handing may differ depending on a location from which an image is captured. For example, when the image is captured from a camera that is attached to the door 14, then the analysis of the image and the determination of handing may be different from when the image is captured from a camera of a mobile device 200. For example, when an image is captured from a camera attached to the door 14, the image may be analyzed to determine locations of objects that are external to the door, such as a strike plate. For example, for an in-swinging door, in response to determining that the strike plate is on a right side of the image, it may be determined that the door 14 is left-handed. On the other hand, in response to determining that the strike plate is on the left side of the image, it may be determined that the door 14 is a right-handed door.

In the example shown, the lockset 100 may be updated with the handing of the door 14 (step 308). For example, if the handing is determined at the mobile device 200, the mobile device 200 may provide data indicating the handing to the lockset 100 (e.g., via Bluetooth). As another example, if the handing is determined at the server 18, then the server 18 may provide data indicating the handing to the lockset 100 (e.g., via Wi-Fi). Any other modalities via which the lockset 100 may communicate may likewise be used to communicate the handing to the lockset 100 (e.g., Thread, Zigbee, Z-Wave, NFC, etc.).

To update the lockset 100 with the determined handing, the lockset 100 may store data in memory indicating the handing of the door to which the lockset 100 is coupled. For example, the lockset 100 may set a parameter stored in the memory 146 that indicates the door handing. The stored data that indicates handing may be used by the processing unit 116 and/or the motor 140 when actuating the latch assembly 112. For example, a rotation of the motor 140 may depend on the data or parameter that indicates a handing of the door to which the lockset 100 is mounted.

In some embodiments, the image analysis process described in connection with FIG. 7 may be used to assist with other aspects of installation of the lockset 100. For example, the image analysis may be used to determine whether the lockset is aligned vertically or parallel with a door edge. As another example, the image analysis may be used to detect a sagging or drooping door inside of the door frame, which may be an indication that there may be alignment issues between the lockset 100 and the door 14. Such issues may cause the lockset 100 to function improperly. As another example, the image analysis may be used to verify or monitor the installation process of the lockset 100 more generally. For example, in some instances, a latch state (e.g., locked or unlocked) and/or a handing of the door 14 may be determined using sensors of the lockset 100 and then validated using aspects of the image processing described herein. As a result, the lock installation process may be verified and audited, thereby providing a positive record that a lock was successfully installed. Other applications of the image processing analysis are also possible.

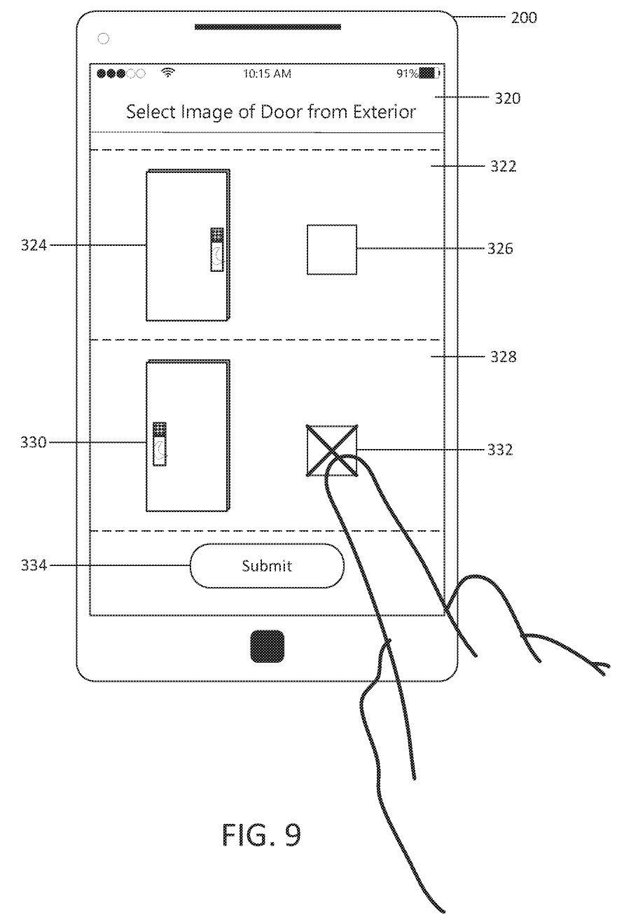

FIG. 9 illustrates a user interface 320 displayed by the mobile device 200. In some embodiments, the user interface 320 is part of the mobile application 220. The user 12 may use the user interface 320 to determine a handing for a door. In the example shown, the user interface 320 includes a first region 322 that includes an image 324 depicting a left-handed door and a selectable input field 326. The user interface 320 further includes a second region 328 that includes a second image 330 depicting a right-handed door and a selectable input field 332. The user interface 320 further includes instructions that the user 12 is to select the image that correspondence with an image of the door 14 from the exterior. In other embodiments, the instructions may request that the user select a representation of the user’s door from an interior. In the example shown, the user 12 may select the input field 326 or the input field 332. Based on the user’s selection, and based on whether the user is selecting an image that matches an exterior or an interior representation of the user’s door, the mobile device 200 (or another device communicatively coupled therewith) may be able to automatically determine a handing of the user’s door. In the example shown, the user 12 selects the input field 332. After selecting the input field 332, the user 12 may select a submit button 334. Based on the user’s selection, and that the image 330 represents the exterior of the user’s door, it may be determined, for example, that the user’s door is right-handed. Thereafter, based on the selection of the user 12, the handing of the door may be provided to one or more of the server 18 or the lockset 100.

In some embodiments, the user interface 320 may include different components than those illustrated in connection with FIG. 9. For example, the user interface 320 may instruct the user to select an image of the door from the interior. As another example, the user interface 320 may include different images of the door 14 or the lockset 100 from which the user 12 may select. Advantageously, the handing of the door may be determined without needing to instruct the user on the concept of handing or without requiring any special lock operations. Instead, by the user simply selecting a door that corresponds to a configuration that matches the user’s door, the mobile device 200 or another device may automatically determine the door’s handing.

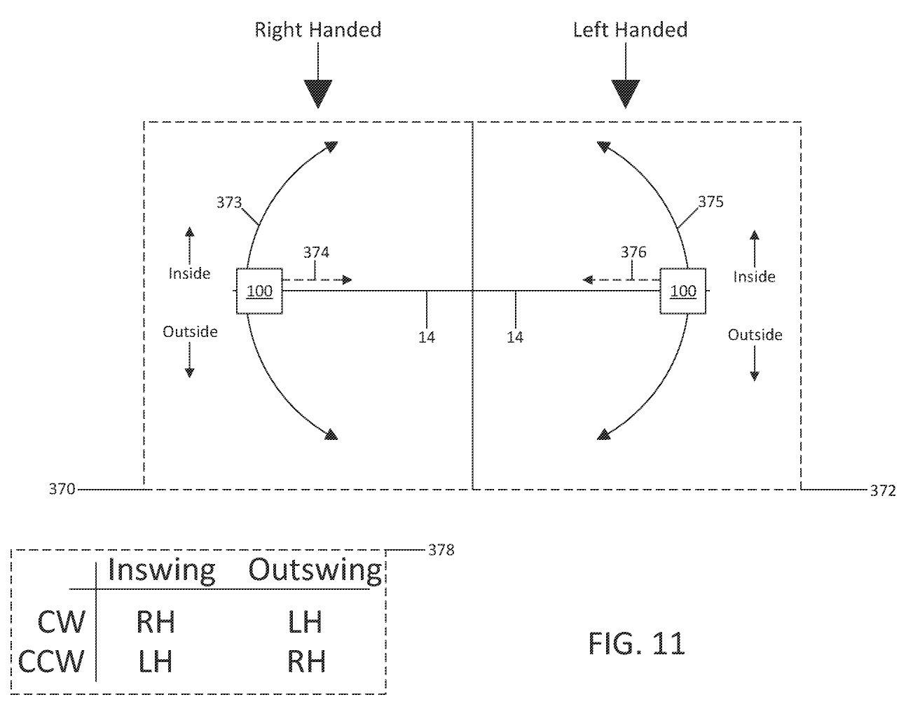

In the examples of FIGS. 10–11, determining handing of the door 14 is based on data collected by sensors of the lockset 100 when swinging the door 14. FIG. 10 illustrates a flowchart of an example method 350 for determining handing. FIG. 11 illustrates schematic examples 370 and 372, which depict determining the handing of a right-handed and left-handed door, respectively, by swinging the doors. In some instances, a measurement device inside or attached to the lockset 100 may always have the same reference point (e.g., inside or outside) and orientation relative to the door. Therefore, when the door 14 is swung, forces and movement that can be detected using the sensors may be used to determine door handing.

Referring to FIG. 10, the example method 350 begins by enabling a sensor (step 352). For example, one or more of an accelerometer, gyroscope, or other sensor that may detect motion of the door may be enabled. In some embodiments, a plurality of sensors may be enabled. In some embodiments, however, a sensor need not be enabled prior to being used to determine a handing of the door 14. As described above in connection with FIG. 6, the sensor may be included in the lockset 100. In some embodiments, however, the sensor may be external to the lockset 100. For example, a sensor of the mobile device 200 may be used. In such an embodiment, the user 12 may place the mobile device 200 near the lockset 100 to use a sensor of the mobile device 200 to detect a force on the lockset 100 or a movement of the lockset 100 by swinging the door 14.

In the example shown, the user 12 may swing the door 14 (step 354). For example, the user 12 may swing the door 14 after installing the lockset 100. In some embodiments, the user 12 may be instructed to swing the door 14 by the mobile application 220. In some embodiments, the user 12 may swing the door 14 during regular use of the door 14. In some embodiments, swinging the door may include moving the door from a closed to an open state or from an open to a closed state. In some embodiments, the user 12 may swing the door for a pre-determined amount of time (e.g., 3 seconds) or for a certain distance (e.g., from a closed state to a half-open state).

In the example shown, the sensor may record a measurement (step 356). For example, an accelerometer may determine a centripetal force on the lockset 100 caused by swinging the door 14. The centripetal force may be toward the hinges of the door 14, and it may be determined whether the centripetal force is on a left side or right side of the lockset 100. In some embodiments, the left side of the lockset 100 may be the left side of the lockset 100 when facing the interior from the lockset 100, and the right side of the lockset 100 may be the right side when facing the interior from the lockset 100. Alternatively, in some embodiments, the left side of the lockset 100 may be the left side of the lockset 100 when facing the exterior from the lockset 100, and the right side of the lockset 100 may be the right side when facing the exterior from the lockset 100. As another example of recording a measurement, the accelerometer may determine a torque on the lockset 100 caused by swinging the door 14. The direction of the torque may be in the same direction of the door swing (e.g., inward or outward) while the velocity is increasing and in the opposite direction of the door swing while the velocity is decreasing. As another example of recording a measurement, a gyroscope may determine an angular velocity of the door swing.

In some embodiments, the lockset 100 may record the measurement caused by swinging only after one or more conditions are satisfied, thereby avoiding a situation in which measurements are captured but the lockset 100 is not yet properly installed. As one example, the lockset 100 may record measurements only after detecting that the lockset 100 is moving in an arc (e.g., thereby indicating that the lockset 100 is mounted to the door 14). As another example, the lockset 100 may record measurements after detecting a predetermined amount of time of swinging (e.g., the door has been swung for at least 2 seconds). As another example, the lockset 100 may record measurements after failing to record other directions of force or for an amount of time (e.g., a movement of the lockset 100 in a vertical direction), thereby indicating that the lockset 100 is fixed to the door 14. As another example, the lockset 100 may record measurements after running the motor 140 to perform a minimum load detection to verify that the motor 140 is coupled with the latch and that the lockset 100 is installed. In some embodiments, other conditions may be used to determine when the lockset 100 records measurements for determining handing.

In the example shown, the handing may be determined based on one or more measurements (step 358). As one example, if a centripetal force is measured, then the door handing may be in the same direction as the centripetal force. For example, if the centripetal force is to the left (e.g., the hinges are to the left of the lockset 100), then it may be determined that the door 14 is left-handed. On the other hand, if the centripetal force is to the right, then it may be determined that the door 14 is right-handed. As another example, a measured force perpendicular to the door 14 and angular velocity may be used to determine door handing. For example, the angular velocity may indicate whether the door 14 is moving in a counterclockwise or clockwise direction. The force perpendicular to the door may be generally in a direction toward an outer edge of the door, and as such its combination with the door movement detection may be used to determine handing, as is further described below in connection with FIG. 11.

In the example shown, the lockset 100 may be updated (step 360) with the determined handing, as described above in connection the step 308 of FIG. 8.

FIG. 11 illustrates a first schematic example 370 and a second schematic example 372, in which the handing of the door 14 may be determined based at least in part on data measured during a swing of the door 14.

In the example 370, the lockset 100 is attached to the door 14, and the lockset 100 may move along an arc 373 as the door 14 is swung. Depending on whether the door 14 is an in-swinging or out-swinging door, the direction in which the lockset 100 may move along the arc 373 may vary. By swinging the door 14, a centripetal force 374 that points toward a door hinge is applied to the lockset 100. As described above in connection with FIG. 11, the lockset 100 may determine a direction of the centripetal force 374 (e.g., right) using an accelerometer and, based on the direction of the centripetal force 374, determine that the door 14 is right-handed, as described above in connection with FIG. 10.

In the example 372, the lockset 100 is attached to the door 14, and the lockset 100 may move along an arc 375 as the door 14 is swung. Depending on whether the door 14 is an inswing or outswing door, the direction in which the lockset 100 may move along the arc 375 may vary. By swinging the door 14, a centripetal force 376 that points toward a door hinge is applied to the lockset 100. As described above in connection with FIG. 11, the lockset 100 may determine a direction of the centripetal force 376 (e.g., left) using an accelerometer and, based on the direction of the centripetal force 376, determine that the door 14 is left-handed, as described above in connection with FIG. 10.

In some embodiments, instead of (or in addition to) determining a centripetal force to determine handing, the lockset 100 may determine one or more of a torque or angular velocity when the door 14 is swung. Using such measurements, the handing of the door 14 may be determined, as illustrated by the table 378. For example, as described above in connection with FIG. 10, a gyroscope may be used to determine the angular velocity and, consequently, whether the door is moving clockwise or counterclockwise. As another example, an accelerometer may determine a torque and thereby determine whether the door is an inswing or outswing door. By combining the rotational direction and the swing direction, the lockset 100 (or another component) may determine whether the door is right-handed or left-handed, as illustrated by the table 378. In some embodiments, determining the handing of the door using one or more of an angular velocity or torque may be used to verify a handing that is determined using a centripetal force, or vice-versa.

In the example of FIGS. 12–14, the handing of the door 14 may be determined by using one or more sensors configured to detect a rotation of a drive shaft 402 of the latch assembly 112. For example, when the door 14 is right-handed, there may be a rotational position of the drive shaft 402 that cannot be reached by the drive shaft 402 when the door 14 is left-handed. Conversely, when the door 14 is left-handed, there may be a rotational position of the drive shaft 402 that cannot be reached by the drive shaft 402 when the door is right-handed. Thus, by detecting that the drive shaft 402 is in one of these rotations that is exclusive to either a right-handed or a left-handed configuration, the handing of the door 14 may be inferred.

FIG. 12 illustrates a left-handed example 400 and a right-handed example 408. The example of FIG. 12 includes the latch assembly 112, the bolt 114, a drive shaft 402, and a reference element 404 that is rotationally coupled with the drive shaft 402. In the left-handed example 400, the drive shaft 402 and the reference element 404 are illustrated in a first position 406a, in which the bolt 114 is retracted, and the drive shaft 402 and the reference element 404 are illustrated in a second position 406b, in which the bolt 114 is extended. In the right-handed example 408, the drive shaft 402 and the reference element 404 are illustrated in a first position 410a, in which the bolt 114 is retracted, and the drive shaft 402 and the reference element 404 are illustrated in a second position 410b, in which the bolt 114 is extended.

The drive shaft 402 may be coupled with the motor 140. When a lock or unlock command is received, the motor 140 may rotate the drive shaft 402, and the rotational movement of the drive shaft 402 may be converted into linear movement of the bolt 114 to retract or extend the bolt 114, depending on whether the lockset is being unlocked or locked. In some instances, the direction of rotation of the drive shaft 402 to extend the bolt 114 may vary depending on whether the bolt 114 is to be extended to a left side or a right side, which may depend on whether the door is left-handed or right-handed. Similarly, the direction of rotation to retract the bolt 114 may depend on whether the door 14 is left-handed or right-handed. Thus, the operation of the motor 140 to rotate the drive shaft 402 may depend on whether the door 14 is left-handed or right-handed.

The reference element 404 may be rotationally coupled with the drive shaft 402. For example, if the drive shaft 402 rotates clockwise, then the reference element 404 may likewise rotate clockwise. If the drive shaft 402 rotates counterclockwise, then the reference element 404 may rotate counterclockwise. In some embodiments, the reference element 404 may be detected by a sensor of the lockset 100, such as the latch assembly sensors 152 described above. In some embodiments, the reference element 404 is a magnet, and its position may be detected by magnetometers. In some embodiments, the reference element 404 is a mechanical protrusion that rotates with the drive shaft 402. In some embodiments, the reference element 404 includes a plurality of detectable elements.

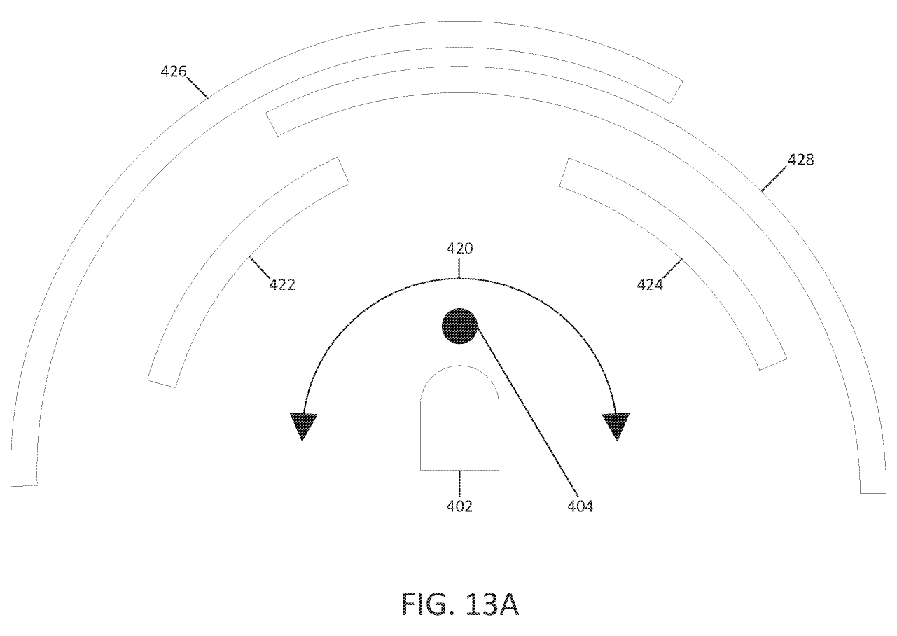

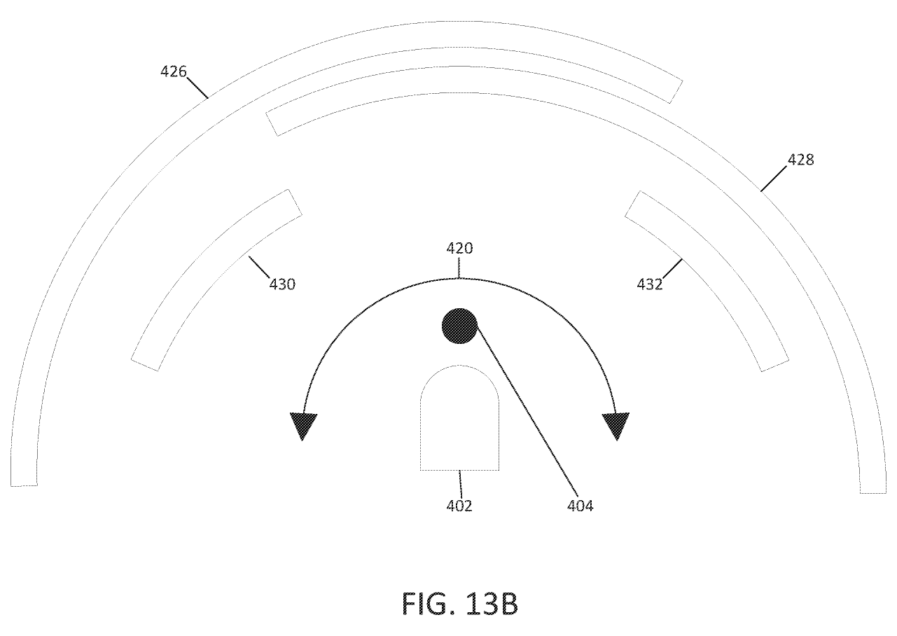

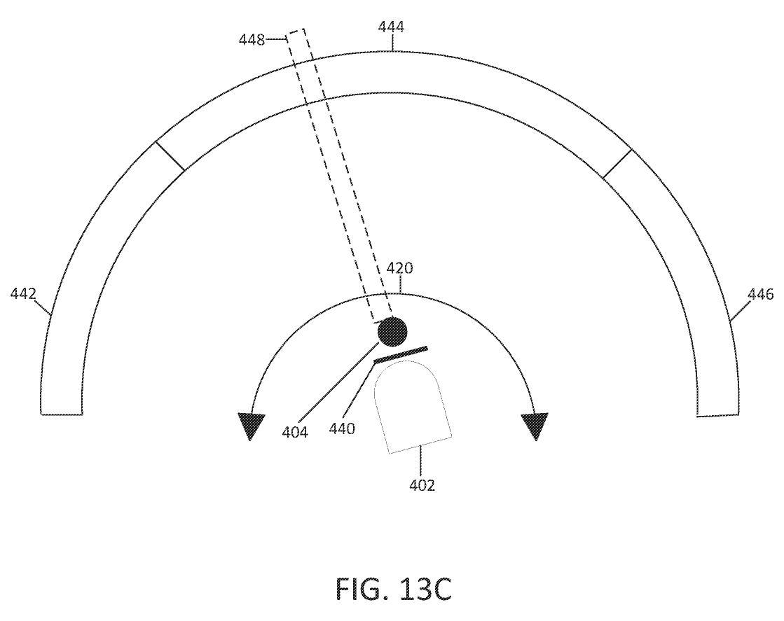

FIG. 13A illustrates a schematic example of using a rotational position of the drive shaft 402 to detect a handing of the door 14. FIG. 13 illustrates the drive shaft 402, the reference element 404, a first sensing region 422, a second sensing region 424, a third sensing region 426, and a fourth sensing region 428. The arc 420 illustrates that the drive shaft 402 and the reference element 404 may be rotated. In the example shown, the arc 420 encompasses about 180 degrees of rotation. However, for any given configuration of the lockset 100 and the latch assembly 114, the drive shaft 402 may not be able to rotate 180 degrees. For example, in a right-handed configuration, the drive shaft 402 may be able to rotate less than 180 degrees (e.g., between 80 and 110 degrees) in a first direction (e.g., counterclockwise), whereas in a left-handed configuration, the driveshaft 402 may be able to rotate less than 180 degrees (e.g., between 80 and 110 degrees) in a second direction (e.g., clockwise) that is different from the first direction.

Each of the sensing regions 422, 424, 426, and 428 may be associated with a sensor that may detect the reference element 404. The characteristics of such sensors may vary depending on the characteristics of the reference element 404. In some embodiments, one or more of the sensors associated with the sensing regions 422–428 may be a digital sensor and one or more of the sensors may be an analog sensor. In some embodiments, each of the one or more sensors may be a same type of sensor, whereas in other embodiments, one or more of the sensors may be a different from another of the one or more sensors. For the embodiment in which the reference element 404 is a magnet, the sensors associated with the sensor regions 422–428 may be magnetic sensors (e.g., a Hall effect sensor, a Tunnel Magneto-Resistance effect sensor, or a magnetometer). For the embodiment in which the reference element 404 is a mechanical protrusion, one or more of the sensors associated with the sensing regions 422–428 may be a trigger limit switch to detect a position of the mechanical protrusion.

In some embodiments, the sensing regions 422 and 424 may correspond with rotational positions that are exclusive to a right-handed door and a left-handed door, respectively. Thus, a sensor associated with the first sensing region 422 may detect that the reference element 404 is rotated such that its rotated position aligns with a rotational orientation covered by the first sensing region 422, as detected by a sensor associated with the first sensing region 422. In response to the detection that the reference element is 404 is rotated such that it is within the first sensing range 422, it may be determined that drive shaft 402 is coupled with a right-handed door. For example, because the drive shaft 402 and the reference element 404 may not be able to rotate to the first sensing region 422 if the drive shaft is coupled to a left-handed door, it may be determined that, if the reference element is detected in the first sensing region 422, the drive shaft 402 is coupled with a right-handed door. In a similar manner, in response to detecting (e.g., using a sensor associated with the second sensing region 424) that the reference element is rotated to the second sensing region 424, it may be determined that the drive shaft is part of a left-handed door.

In some embodiments, the sensors associated with the sensing regions 422 and 424 may be selectively activated and deactivated. For example, a sensor associated with the third sensing region 426 may determine whether the reference element 404 is rotated such that it is aligned with a rotational orientation encompassed by the third sensing region 426. If so, the sensor associated with the first sensing region 422 may be activated. If not, then the sensor associated with the first sensing region 422 may be deactivated. For example, in response to determining that the reference element 404 is not rotated such that it is within the third sensing region 426 (e.g., the drive shaft is rotated at lest 45 degrees or another amount in the clockwise direction), then the sensor associated with the first sensing region 422 may be deactivated. In some embodiments, in response to detecting that the reference element 404 exited the third sensing region 426, the sensor associated with the first sensing region 422 may be deactivated.

In a similar manner, the sensor associated with the second sensing region 424 may be activated in response to determining that the reference element 404 is located within the fourth sensing region 428 and may be deactivated in response to determining that the reference element 404 is not located within the fourth sensing region 428. In some embodiments, by selectively activating and deactivating sensors associated with the sensing regions 422 and 424, the lockset 100 may save power and the rotational position of the reference element 404 may be more accurately determined. It is noted that the elements illustrated in FIG. 13, including the illustrated coverage of the sensing regions 422–428, may not be to scale and are depicted for example purposes.

In some embodiments, a different configuration of sensors may be used than depicted in FIG. 13A. For example, a first and second sensor may be used to detect the reference element 404 in the first sensing region 422 and the second sensing region 424, respectively. In some embodiments, the reference element 404 may be configured to reach a point in each of the first sensing region 422 and the second sensing region 424 irrespective of door handing. Additionally, a third sensor may be configured to detect a degree of rotation, or a height, of the reference element 404. For example, the third sensor may be configured to determine how many degrees the reference element 404 has been rotated along the arc 420 from a top position depicted in FIG. 13A. By determining a degree of rotation, the third sensor may also enable a calculation of a height of the reference element 404. In some embodiments, the third sensor is activated in response to a detection of the reference element 404 in the first sensing region 422 or the second sensing region 424. The third sensor may be deactivated if the reference element is in neither the first sensing region 422 nor the second sensing region 424. In some embodiments, the third sensor is an analog sensor and the first and second sensors are digital sensors.

In some embodiments, in response to determining, using a plurality of sensors, that the reference element 404 is, for example, in the first sensing region 422 and that the reference element 404 has rotated sufficiently far (e.g., 30 degrees or another angle from a top position), or that the reference element 404 is at a certain height, it may be determined that the reference element 404 is in a position exclusive to right-handed doors, and that, therefore, the door is right-handed. Conversely, in response to determining that the reference element 404 is in the second sensing region 424 and that the reference element 404 has rotated sufficiently far (e.g., 30 degrees or another angle from a top position), or that the reference element 404 is at a certain height, it may be determined that the reference element 404 is in a position exclusive to left-handed doors, and that, therefore, the door is left-handed. Additional configurations using three sensors are likewise possible in which a combination of different data from two of the three sensors enables a determination that the reference element 404 is in a position exclusive to left or right-handed doors.

FIG. 13B illustrates a second schematic example of using a rotational position of the drive shaft 402 to detect a handing of the door 14. In the example of FIG. 13B, the sensing regions 430 and 432 replace the sensing regions 422 and 424 of FIG. 13A, respectively. As described in connection with FIG. 13A, the sensing regions 430 and 432 may be associated with respective sensors, such as digital or analog sensors, that identify whether the reference element 404 is rotated into the respective sensing regions 430 and 432.

In the example of FIG. 13B, the regions 426 and 428 correspond to rotation areas that are exclusive to right-handed and left-handed doors, respectively. In the example of FIG. 13B, the sensing region 430 does not overlap with the region 428, and the sensing region 432 does not overlap with the region 426. Accordingly, in the example of FIG. 13B, handing may advantageously determined using only two sensors, such as a first sensor associated with the sensing region 430 and a sensor associated with the sensing region 432. In response to the first sensor determining that the reference element 404 is in the sensing region 430, it can be determined that the door is right-handed, because the reference element 404 rotated past the region 428 and into a rotation that is exclusive to right-handed doors. In contrast, in response to the second sensor determining that the reference element 404 is in the sensing region 432, it can be determined that the door is left-handed, because the reference element 404 rotated past the region 426 and into a rotation that is exclusive to left-handed doors.

FIG. 13C illustrates a third schematic example of using a rotational position of the drive shaft 402 to detect a handing of the door 14. In the example of FIG. 13C, a single sensor can be used to determine a rotation of the draft shaft 402 and a handing of the door 14. In the example of FIG. 13C, a metallic object 440 is rotationally coupled with the drive shaft 402. Although the single sensor used in connection with FIG. 13C is described as an inductive sensor, it may also be a different type of sensor. For example, the single sensor may be an ultrasonic sensor.

In the example of FIG. 13C, the lockset 100 includes an inductive sensor that can determine a position of the metallic object 440 by measuring a change to a magnetic field as the metallic object 440 rotates with the drive shaft. As a result, the position of the metallic object 440 can be determined, and the position of the metallic object can be used to determine a rotational direction and degree of rotation of the drive shaft 402.

In some embodiments, the inductive sensor can determine an absolute position of the metallic object. For example, rather than determining whether or not the metallic object 440 is present in a region, the inductive sensor can determine, in some embodiments, where the metallic object is located and then determine whether that location corresponds to a region. Example regions are shown as the regions 442, 444, and 446. In some embodiments, one or more of the rotations 442, 444, and 446 can correspond to a rotational region that is exclusive to particular handing. For example, the inductive sensor can detect the rotation 448 shown in the example of FIG. 13C. Based on the rotation 448, it can be determined that the drive shaft 402 and the metallic object 440 have rotated to the region 444. In some embodiments, if the electronic lockset 100 determines that the rotation 448 in located in the region 442 or 446, then the electronic lockset 100 can determine that the drive shaft 402 has rotated to a position that is exclusive to right-handed or left-handed doors.

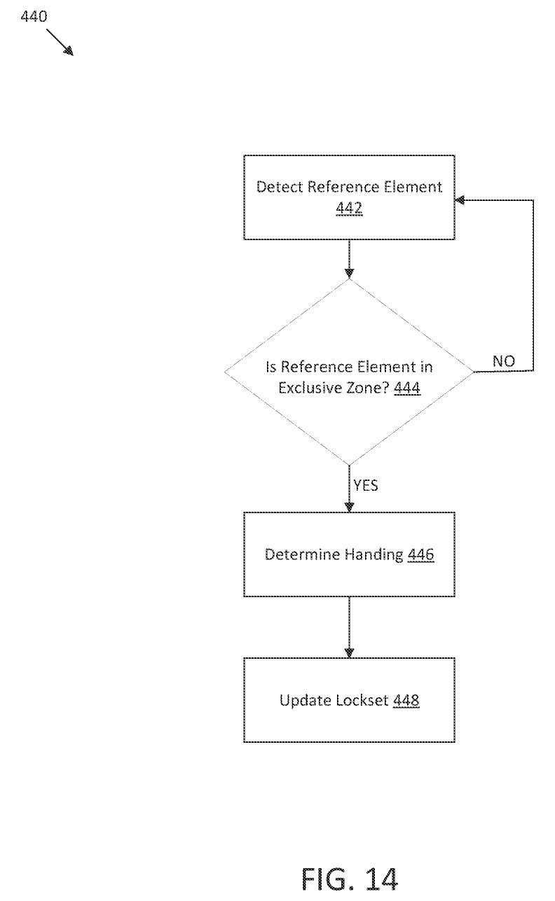

FIG. 14 is a flowchart of a method 440 for determining door handing based on a position of the reference element 404, which may be rotationally coupled with the drive shaft 402. In some embodiments, aspects of the method 400 may be performed by the processing unit 116 and by using the latch assembly sensors 152, which are further described above in connection with FIG. 6. However, in some embodiments, different components than those described in connection with the example of FIG. 14 may be used to perform operations of the method 440.

In the example shown, the reference element 404 may be detected (step 442). For example, one or more of the sensors associated with the sensing regions 422–428 may detect the reference element 404. In some embodiments, detecting the reference element 404 may be performed during an installation process of the lockset 100. For example, as part of installation, the processing unit 116 may run the motor 140 to actuate the latch assembly and extend or retract the bolt 114. Further, the processing unit 116 may try to run the motor 140 in both a first direction and a second direction, but given a configuration of the lockset 100, the motor 140 may be prevented from running in the first or second direction (e.g., depending on a handing of the door 14, the bolt 114 may only be able to extend in a first direction but not a second direction, thereby preventing the motor 140 from running in a direction). During such a test operation of the motor 140 and the latch assembly 112, the reference element 404 may be detected. In some embodiments, the reference element 404 may be detected after a user manually operates the lockset 100 using a turn piece or a key. In some embodiments, the reference element 404 may be detected when the lockset 100 is operated after otherwise being instructed by a user (e.g., via the keypad 120, via a touch device, or via wireless communication). In some embodiments, a special installation instruction is not required for the reference element 404 to be detected and for handing to be determined.

In the example shown, the processing unit 116 may determine whether the reference element 404 is located within an exclusive zone. For example, the processing unit 116 may determine whether the sensor is in a rotational zone that is exclusive to a right-handed door or a left-handed door. For example, the processing unit 116 may determine whether a first sensor detected that the reference element 404 is in the first sensing region 422 or whether a second sensor detected that the reference element 404 is in the second sensing region 424. Furthermore, in some embodiments, the processing unit 116 may determine not only whether the reference element 404 is in the first sensing region 422 or the second sensing region 424, but may also determine a degree of rotation, or a height, of the reference element as part of determining whether the reference element is in an exclusive zone. For example, using a sensor (e.g., an analog sensor), the processing unit 116 may determine whether the reference element has rotated sufficiently far (e.g., 30 degrees) or is sufficiently displaced from a top point, and the processing unit 116 may also determine whether the reference element is located in the first sensing region 422 or the second sensing region 424. Based on this determination of the reference element’s 420 degree of rotation, or height, and location in a sensing region, the processing unit may determine that the reference element is in an exclusive zone.

In response to determining that the reference element is in an exclusive zone (step 444) (e.g., taking the “YES” branch), the processing unit 116 may determine handing. In response to determining that the reference element is not in an exclusive zone (e.g., taking the “NO” branch), the method 440 may return to the step 442. Additionally, as described above in connection with FIG. 13, one or more sensors may be activated or deactivated in response to detecting the reference element 404, even if it is determined that the reference element 404 is not in an exclusive zone.

In the example shown, the processing unit 116 may determine handing (step 446). In response to determining that the reference element 404 is located in a position that is exclusive to a left-handed door, the processing unit 116 may determine that the door is left-handed. Similarly in response to determining that the reference element 404 is located in a position that is exclusive to a right-handed door, the processing unit 116 may determine that the door is right-handed.

In the example shown, the lockset 100 may be updated with information indicating the determined handing of the door (step 448). For example, the processing unit 116 may store in memory information indicating that the door is right-handed or left-handed. An example of updating the lockset 100 is described above in connection with the step 308 of FIG. 8.

In some embodiments, different sensor configurations and operations may be used to determine a handing of the door 14 based on the rotation of the drive shaft 402 than those described in connection with FIGS. 12–14. Additionally, in some embodiments, sensors may be used to determine a position of other aspects of the latch assembly 112 to determine handing. For example, in some embodiments, determining a position or movement of the bolt 114 may be used to determine handing. Additionally, in some embodiments, sensors and processes used for other aspects of installation of the lockset 100 (e.g., determining a locked and unlocked state) may be used to determine handing.

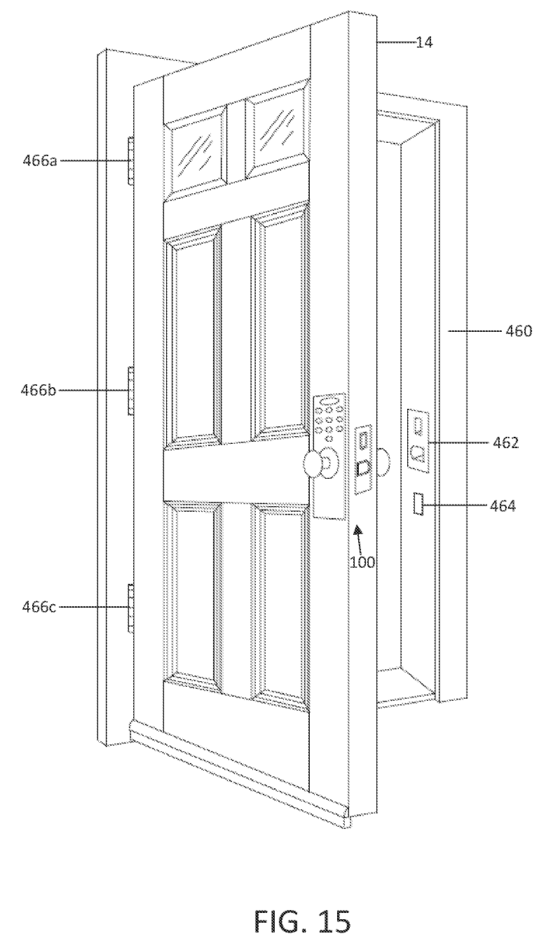

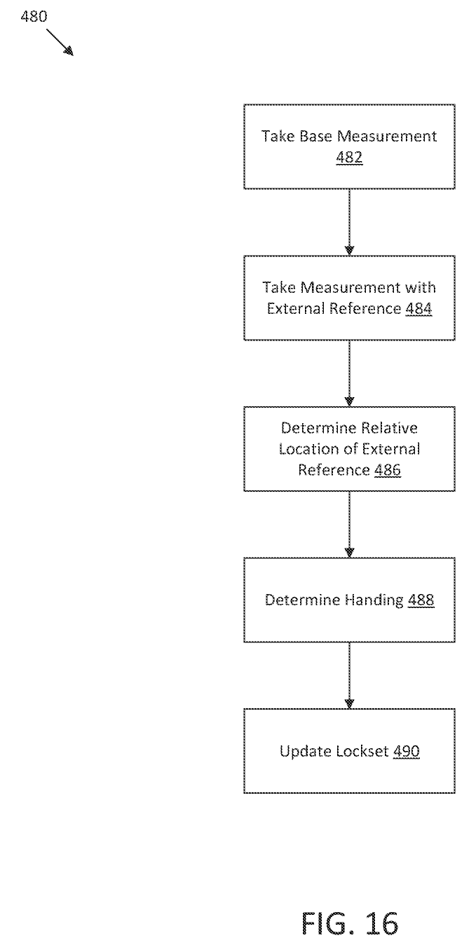

In the examples of FIGS. 15–16, handing of the door 14 may be determined based on a location of a reference point that is external to the lockset 100. In the examples of FIGS. 15–16, a sensor of the lockset 100 or a sensor that is communicatively coupled with the lockset 100 may determine a location of an external reference relative to the lockset, and based on this relative location, determine handing for the door 14.

FIG. 15 illustrates a perspective view of a partially opened example of the door 14, which includes the lockset 100. Furthermore, the example of FIG. 15 includes components that are external to the door 14, such as a door frame 460, a door jamb 462, an external reference element 464, and hinges 466a–c.

In the example shown, the lockset 100 may determine a relative location of one or more of the door frame 460, the door jamb 462, or the external element 464. For example, the lockset 100 may determine that one or more of the door frame 460, the door jamb 462, or the external element 464 are to the right of the lockset 100, and as a result, it may be determined that the door is left-handed. Similarly, in some embodiments, the lockset 100 may determine that one or more of the hinges 466a–c are on the left of lockset 100, and as a result, it may be determined that the lockset is left-handed. In some embodiments, determining the relative locations of the external references may performed when the door 14 is in a closed position, whereas in other embodiments, determining the relative locations of the external references may be performed when the door 14 is open. Example operations for determining a relative location of a reference element are described below in connection with FIG. 16.

The door frame 460 may be a structure that defines an opening for the door 14. The door frame 460 may include door trim, door casing, weather strips, and other components. The door jamb 462 may include a strike plate into which a bolt 114 or latch of the lockset 100 may be extended. The reference element 464 may be an object that can be sensed by a sensor of the lockset 100 or a sensor that is communicatively coupled with the lockset 100. In some embodiments, the reference element 464 is a magnet. In some embodiments, the reference element 464 is indica that may be detected by a camera or another sensor. In some embodiments, the reference element 464 is embedded into or coupled with the door frame 460 or the door jamb 462.

FIG. 16 is a flowchart of an example method 480 for determining door handing based on a location of an external reference. In the example of FIG. 16, operations of the method 480 are described as being performed by the lockset 100. For example, the lockset 100 may use the processing unit 116 and one or more of the sensors 154 to perform operations of the method 480. In other embodiments, different components may perform aspects operations of the method 480.

There are various sensing and measurement means that the lockset 100 may use to determine a location of an external reference. As an example, the lockset 100 may use a magnetometer, an infrared sensor, a radio frequency sensor, an ultrasound device, a camera, or a sensor used to determine whether a door is in a closed stated. Depending on a sensor used by the lockset 100, the characteristics of the external reference (e.g., the door frame 460, the door jamb 462, the reference element 464, or the hinges 466a–c) may vary. For example, if the lockset 100 uses a magnetometer, then the external reference may be a magnet or may be ferrous material. As another example, if the lockset 100 uses an infrared sensor or a radio frequency sensor, then the presence of the external reference may be detected using lidar or radar, respectively. As another example, if the lockset 100 uses an ultrasound sensor, then the presence of the external reference may be detected using sonar, or sound waves. As another example, if the lockset 100 uses a camera, then the external reference may be an object or marking that is recognizable by a computer vision program that processes an image captured by the camera.

For illustrative purposes, the method 480 is described as being performed using a magnetometer in the lockset 100 that detects a magnet as an external reference. However, as described above, the sensing and measurement means that may be used in connection with FIGS. 15–16 are not limited to a magnetometer and a magnet.

In the example shown, the lockset 100 may take a base measurement (step 482). For example, the lockset 100 may capture a measurement using the magnetometer prior to placing the external reference (e.g., a magnet) at an external reference point, such as a door jamb or door frame. This measurement without the external reference point may be a baseline measurement, and a normalization process may be executed. In some embodiments, a base measurement may not be required. Whether a base measurement is required may depend on the type of external reference that is used and the manner in which it is being measured. For example, if the external reference is an object that may be detected using video or another approach, then a base measurement may not be required.

In the example shown, the lockset 100 may take a measurement that includes the external reference (step 484). For example, the magnet may be placed (e.g., by a user), and then a second measurement using the magnetometer may be taken. As another example, the user need not place the external reference. For example, the external reference may be an object that is already present and detectable by the lockset 100. For example, the external reference may be the door jamb itself, a material associated with the door jamb (such as a reflective material), or another feature that is already present on or nearby the door 14 or lockset 100.

In the example shown, the lockset 100 may determine a relative location of the external reference (step 486). For example, the lockset 100 may compare the baseline measurement without the external reference with the measurement taken that included the external reference. In some embodiments, any differences between the measurements may be assumed to be caused by the external reference. Thus, a location of the external reference relative to the lockset 100 may be derived based on a comparison between the measurements. For example, the lockset 100 may determine whether the external reference is to the left or to the right. In some embodiments, the lockset 100 may determine the location of the external reference without comparing multiple measurements. For example, if the lockset 100 is using video, or another approach that may not require calibration, then the lockset 100 may analyze the data captured at the step 484 to identify a location of the external reference and whether it is positioned to the left or right of the lockset 100. Such a determination may not require a comparison with a baseline measurement, since the external reference may be detectable without a calibration step.

In the example shown, the lockset 100 may determine handing based on the location of the external reference (step 488). For example, if it is determined that a location of the external reference is on the right, and it is known by the lockset 100 that a position of the external reference corresponds with a position of the door jamb 462, then it may be determined that the door is left-handed. On the other hand, if it is determined that that the door jamb is on the left (e.g., because the external reference is on the left), then it may be determined that the door is right-handed. Once the handing is determined, the lockset 100 may be updated (step 490), an example of which is described above in connection with the step 308 of FIG. 8.

In some embodiments, one or more aspects of the method 480 may vary depending on the sensing and measurement device used to detect the external reference. For example, if a camera is used, then determination of handing may depend on a location of the external reference relative to the camera. For example, on an in-swinging door, a camera may be fastened to the door. When the door is swung, the camera may capture an image showing that the external reference (e.g., a door jamb) is located on a right-hand side of the image, as recognized, in some embodiments, by an image processing application. As a result, it may be determined that the door is left-handed. Additionally, for configurations in which a camera is not attached to a door, then determining the handing of a door based on a detected external reference may depend on whether the camera is located on an exterior or interior side of the door.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. An electronic lockset mounted to a door, the electronic lockset comprising:
a latch assembly comprising a drive shaft;
a reference element rotationally coupled with the drive shaft;
a sensor;
a processor; and
memory storing instructions;
wherein the instructions, when executed by the processor, cause the electronic lockset to:
detect, using the sensor, a rotational position of the reference element;
based on the rotational position of the reference element, determine a handing of the door;
wherein determining the handing of the door comprises (i) determining that the door is right-handed after determining that the rotational position of the reference element is in a rotational position that is exclusive to a right-handed door; or (ii) determining that the door is left-handed after determining that the rotational position of the reference element is in a rotational position that is exclusive to a left-handed door.

2. The electronic lockset of claim 1,
wherein the sensor comprises a first sensor configured to detect the reference element in the rotational position that is exclusive to the right-handed door;
wherein the sensor comprises a second sensor configured to detect the reference element in the rotational position that is exclusive to the right-handed door.

3. The electronic lockset of claim 1,
wherein the sensor comprises at least three sensors;
wherein a first sensor of the at least three sensors corresponds to detecting a right-handed door;
wherein a second sensor of the at least three sensors corresponds to detecting a left-handed door;
wherein a third sensor of the at least three sensors is configured to determine a degree of rotation of the reference element;
wherein the instructions, when executed by the processor, cause the electronic lockset to activate the third sensor in response to detecting the reference element with the first sensor or the second sensor; and
wherein determining the handing of the door comprises using the third sensor to determine the degree of rotation of the reference element.

4. The electronic lockset of claim 1,
wherein the sensor comprises at least two sensors;
wherein the instructions, when executed by the processor, further cause the electronic lockset to:
detect the reference element using a first sensor of the at least two sensors; and
in response to detecting the reference element using the first sensor, activate a second sensor of the at least two sensors.

5. The electronic lockset of claim 4,
wherein the instructions, when executed by the processor, further cause the electronic lockset to detect the reference element using the second sensor; and
wherein determining the handing of the door comprises detecting the reference element using the first sensor and the second sensor.

6. The electronic lockset of claim 4, wherein the first sensor is a digital sensor and the second sensor is an analog sensor.

7. The electronic lockset of claim 4,
wherein the instructions, when executed by the processor, further cause the electronic lockset to:
fail to detect the reference element using the first sensor; and
in response to failing to detect the reference element using the first sensor, deactivate the second sensor.

8. The electronic lockset of claim 1, wherein the sensor consists of one sensor configured to detect a movement of the reference element and an absolute position of the reference element.

9. The electronic lockset of claim 8,
wherein the sensor is an inductive sensor; and
wherein the reference element comprises a metallic object.

10. The electronic lockset of claim 1,
wherein the sensor comprises at least four sensors;
wherein the instructions, when executed by the processor, cause the electronic lockset to:
detect the reference element using a first sensor of the at least four sensors;
in response to detecting the reference element using the first sensor, activate a second sensor of the at least four sensors;
detect the reference element using a third sensor of the at least four sensors; and
in response to detecting the reference element using the third sensor, activate a fourth sensor of the at least four sensors.

11. The electronic lockset of claim 1,
wherein the reference element is a magnet that is coupled to the latch assembly; and
wherein the sensor is a plurality of magnetometers.

12. The electronic lockset of claim 1, wherein the instructions, when executed by the processor, cause the electronic lockset to:
prior to detecting, using the sensor, the rotational position of the reference element, actuate a motor to rotate the drive shaft;
wherein rotating the drive shaft causes the reference element to rotate to a position that is detectable by the sensor.

13. The electronic lockset of claim 12, wherein actuating the motor to rotate the drive shaft is automatically performed during an installation process of the electronic lockset.

14. The electronic lockset of claim 1,
wherein the instructions, when executed by the processor, further cause the electronic lockset to receive, from a mobile device, the handing of the door;
wherein the mobile device is configured to:
display, via a graphical user interface, a first image of a left-handed door with a lockset positioned on a first side of the door;
display, via the graphical user interface, a second image of a right-handed door with the lockset positioned on the second side of the door;
display, via the graphical user interface, instructions for a user to select the first image or the second image as representing an exterior or an interior of the door ;
receive, via the graphical user interface, a selection of the first image or the second image from the user;
based on the selection of the first image or the second image, automatically identify the handing of the door; and
send the handing to the electronic lockset.

15. A method for determining a handing of a door, the method comprising:
by an electronic lockset:
detecting, using a sensor, a rotational position of a reference element rotationally coupled with a latch assembly; and
automatically determining that the door is right-handed by determining that the rotational position is exclusive to right-handed doors, wherein the reference element cannot be in the rotational position for left-handed doors.

16. The method of claim 15,
wherein the sensor comprises a first sensor configured to detect the reference element in the rotational position that is exclusive to the right-handed door; and
wherein the sensor comprises a second sensor configured to detect the reference element in the rotational position that is exclusive to the right-handed door.

17. The method of claim 15,
wherein the sensor comprises at least two sensors;
wherein the instructions, when executed by the processor, further cause the electronic lockset to:
detect the reference element using a first sensor of the at least two sensors; and
in response to detecting the reference element using the first sensor, activate a second sensor of the at least two sensors.

18. The method of claim 16, wherein determining that the door is right-handed comprises using the second sensor to determine the rotational position of the reference element.

19. A system comprising:
an electronic lockset; and
a mobile device;
wherein the mobile device is configured to:
display, via a graphical user interface of a mobile application, a first image of a left-handed door with a lockset positioned on a first side of the door;
display, via the graphical user interface of the mobile application, a second image of a right-handed door with the lockset positioned on a second side of the door;
display, via the graphical user interface of the mobile application, instructions for a user to select the first image or the second image as representing an exterior or an interior of the door ;
receive, via the graphical user interface of the mobile application, a selection of the first image or the second image from the user;
based on the selection of the first image or the second image, automatically identify the handing of the door; and
send the handing to the electronic lockset.

20. The system of claim 19, wherein the electronic lockset comprises:
a latch assembly comprising a drive shaft;
a reference element rotationally coupled with the drive shaft;
a sensor;
a processor; and
memory storing instructions;
wherein the instructions, when executed by the processor, cause the electronic lockset to:
detect, using the sensor, a rotational position of the reference element;
based on the rotational position of the reference element, determine the handing of the door;
wherein determining the handing of the door comprises (i) determining that the door is right-handed after determining that the rotational position of the reference element is in a rotational position that is exclusive to a right-handed door; or (ii) determining that the door is left-handed after determining that the rotational position of the reference element is in a rotational position that is exclusive to a left-handed door.
